(19) United States
(12) Patent Application Publication
(10) Pub. No.: US 2025/0305350 A1
(43) Pub. Date: Oct. 2, 2025

(54) WINDOW ASSEMBLIES AND MANUFACTURING METHODS THEREOF

(71) Applicant: Torsion Group Corp., Strongsville, OH (US)

(72) Inventor: Kevin Wright, Greenfield, IL (US)

(21) Appl. No.: 18/621,897

(22) Filed: Mar. 29, 2024

(51) Int. Cl. E06B 3/58; E06B 5/10

(52) U.S. Cl. CPC E06B 3/58; E06B 5/10

(57) ABSTRACT

A window assembly includes a frame and a window glazing. The frame has an interior frame element and an exterior frame element. The interior frame element has a first internal surface, a first outer engagement portion extending from the internal surface, and a first inner engagement portion extending from the first internal surface. The exterior frame element has a second internal surface, a second outer engagement portion extending from the second internal surface, and a second inner engagement portion extending from the second internal surface. The interior and exterior frame elements are configured to be connected to each other with the window glazing disposed therebetween. A first length of the first inner engagement portion is greater than or equal to a second length of the second inner engagement portion.

### TECHNICAL FIELD

The present invention relates generally to window frames and, more specifically, window frame assemblies for attaching to a door, such as a garage door.

### BACKGROUND

Garage doors typically include a plurality of panels that are configured to cover an opening of the garage, where each panel is hingedly connected to an adjacent panel. The panels are typically attached to a track such that the panels can move along the track from a closed position in which the panels cover the opening of the garage and an open position in which the panels do not cover the opening of the garage. Window assemblie(s) can be attached to one or more of the panels to allow for light to enter into the garage through the window assemblie(s), to allow a user to view an exterior of the garage, to enhance an aesthetic appeal of the garage door, etc.

### SUMMARY

An example window assembly includes a frame and a window glazing. The frame has an interior frame element and an exterior frame element. The interior frame element has a first internal surface, a first outer engagement portion extending from the internal surface, and a first inner engagement portion extending from the first internal surface. The first inner engagement portion is integrally connected to the first internal surface. The exterior frame element has a second internal surface, a second outer engagement portion extending from the second internal surface, and a second inner engagement portion extending from the second internal surface. The second inner engagement portion is integrally connected to the second internal surface. The interior and exterior frame elements are configured to be connected to each other such that the first outer engagement portion and the second outer engagement portion engage a door or other surface. The window glazing is disposed between the interior and exterior frame elements. The first and second inner engagement portions are aligned with the window glazing. A first length of the first inner engagement portion is greater than or equal to a second length of the second inner engagement portion.

An example garage door assembly includes a garage door and a window assembly. The garage door has an opening. The window assembly has an interior frame element, an exterior frame element, and a window glazing. The interior frame element has a first internal surface, a first outer engagement portion extending from the first internal surface, and a first inner engagement portion extending from the first internal surface. The first engagement portion is integrally connected to the first internal surface. The exterior frame element has a second internal surface, a second outer engagement portion extending from the second internal surface, and a second inner engagement portion extending from the second internal surface. The second inner engagement portion is integrally connected to the second internal surface. The window glazing is disposed between the interior and exterior frame elements such that the first inner engagement portion and the second inner engagement portion are aligned with the window glazing. A first length of the first inner engagement portion is greater than a second length of the second inner engagement portion. The window assembly is positioned within the opening of the garage door such that the first outer engagement portion and the second outer engagement portion engage the garage door.

An example method of assembling a garage door includes providing a garage door and a window assembly. The garage door has an opening and a thickness. The window assembly has an exterior frame element, an interior frame element, and a window glazing. The exterior frame element has a first inner engagement portion that extends from a first internal surface of the exterior frame element, where the first inner engagement portion has a first length. The interior frame element has a second inner engagement portion that extends from a second internal surface of the exterior frame element, where the second inner engagement portion has a second length that is greater than or equal to the first length. The method further includes securing the exterior frame element to the interior frame element such that the window assembly is attached to the garage door and the window glazing is positioned between the exterior and interior frame elements and disposed within the opening of the garage door. The second length of the second inner engagement portion of the interior frame element is determined based on the thickness of the garage door.

An example method of manufacturing a window assembly for a garage door includes providing a mold for creating both an exterior frame element and an interior frame element of the window assembly. The mold has one or more detachable molding elements and one or more alternative molding elements, where the one or more alternative molding elements are configured to replace the one or more detachable molding elements in the mold. The one or more detachable molding elements are configured to create a first inner engagement portion for the exterior frame element, and each of the one or more detachable molding elements and the one or more alternative molding elements are configured to create a second inner engagement portion for the interior frame element. The method further includes creating the exterior frame element using the mold by injection molding such that the exterior frame element has the first inner engagement portion, where the first inner engagement portion has the first length based on a cavity defined by the one or more detachable molding elements. The method further includes creating an interior frame element using the mold by injection molding such that the interior frame element has the second inner engagement portion, where the second inner engagement portion has a second length based on one of the cavity defined by the one or more detachable molding elements or a second cavity defined by the one or more alternative molding elements. The second length of the second inner engagement portion is equal to the first length of the first inner engagement portion when the one or more detachable molding elements are used to create the interior frame element, and the second length is greater than the first length when the one or more alternative molding elements are used to create the interior frame element.

### BRIEF DESCRIPTION OF THE DRAWINGS

FIG. 1 is a perspective view of an example window assembly attached to a garage door, showing an exterior of the window assembly;

FIG. 2 is a perspective view of the window assembly attached to the garage door of FIG. 1, showing an interior of the window assembly;

FIG. 3 is a perspective view of the window assembly of FIG. 1 when detached from the garage door;

FIG. 4 is a perspective view of an example exterior frame element of the window assembly of FIG. 1, showing an external portion of the exterior frame element;

FIG. 5 is a perspective view of the exterior frame element of FIG. 4, showing an internal portion of the exterior frame element;

FIG. 6 is a rear view of the exterior frame element of FIG. 4, showing the internal portion of the exterior frame element;

FIG. 7 is a left-side view of the exterior frame element of FIG. 4;

FIG. 8 is a perspective view of an example interior frame element of the window assembly of FIG. 1, showing an external portion of the interior frame element;

FIG. 9 is a perspective view of the interior frame element of FIG. 8, showing an internal portion of the interior frame element;

FIG. 10 is a front view of the interior frame element of FIG. 8, showing the internal portion of the interior frame element;

FIG. 11 is a right-side view of the interior frame element of FIG. 8;

FIG. 12 is a cross-sectional view of the window assembly of FIG. 1 taken along the line A-A shown in FIG. 1, where the garage door that the window assembly is attached to has a first width;

FIG. 13 is a cross-sectional view of the window assembly of FIG. 1 taken along the line A-A shown in FIG. 1, where the garage door that the window assembly is attached to has a second width that is greater than the first width shown in FIG. 12;

FIG. 14 is a cross-sectional view of the window assembly of FIG. 1 taken along the line A-A shown in FIG. 1, where the garage door that the window assembly is attached to has a third width that is greater than each of the first width shown in FIG. 12 and the second width shown in FIG. 13;

FIG. 15 is a perspective view of an example impact element that can be used with the window assembly of FIG. 1;

FIG. 16 is a left-side view of the impact element of FIG. 15;

FIG. 17 is a front view of the impact element of FIG. 15;

FIG. 18 is a rear perspective view of the exterior frame element of FIGS. 4-7 with the impact element of FIGS. 15-17 attached to an internal portion of the exterior frame element;

FIG. 19 is a rear view of the exterior frame element of FIGS. 4-7 with the impact element of FIGS. 15-17 attached to an internal portion of the exterior frame element;

FIG. 20 is a cross-sectional view of the window assembly of FIG. 1 taken along the line A-A shown in FIG. 1, where the impact element of FIGS. 15-17 is attached to the internal side of the exterior frame element;

FIG. 21 is a perspective view of an example impact element that can be used with the window assembly of FIG. 1;

FIG. 22 is a left-side view of the impact element of FIG. 20;

FIG. 23 is a front view of the impact element of FIG. 20;

FIG. 24 is a rear perspective view of the exterior frame element of FIGS. 4-7 with the impact element of FIGS. 21-23 attached to an internal portion of the exterior frame element;

FIG. 25 is a rear view of the exterior frame element of FIGS. 4-7 with the impact element of FIGS. 21-23 attached to an internal portion of the exterior frame element;

FIG. 26 is a cross-sectional view of the window assembly of FIG. 1 taken along the line A-A shown in FIG. 1, where the impact element of FIGS. 21-23 is attached to the internal side of the exterior frame element;

FIGS. 27-31 illustrate various shapes for the window assembly of FIG. 1;

FIG. 32 is a perspective view of an example garage door having exterior channels;

FIG. 33 is a partial perspective view of the window assembly of FIG. 1 being attached to the garage door shown in FIG. 32, where the exterior frame element of the window assembly has example ribs that align with channels of the garage door;

FIG. 34 is a left-side view of the exterior frame element of the window assembly of FIG. 33;

FIG. 35 is a cross-sectional view of the window assembly of FIG. 1 being attached to another example garage door that does not include an insulation member, where the exterior frame element of the window assembly has example ribs that align with exterior channels of the garage door, and where the interior frame element of the window assembly has slots for aligning with interior ribs of the garage door;

FIG. 36 is a left-side view of the interior frame element of FIG. 35;

FIG. 37 is a left-side view of the exterior frame element of FIG. 35;

FIG. 38 is a top schematic view of an example mold assembly used for making interior and exterior frame elements of a window frame assembly;

FIG. 39 is a cross-sectional schematic view of the mold assembly of FIG. 38 taken along the line B-B shown in FIG. 38;

FIG. 40 illustrates an example molding element for the mold assembly of FIG. 38;

FIG. 41 illustrates an example molding element for the mold assembly of FIG. 38;

FIG. 42 illustrates an example molding element for the mold assembly of FIG. 38; and

FIG. 43 illustrates an example molding element for the mold assembly of FIG. 38.

### DETAILED DESCRIPTION

The Detailed Description describes exemplary embodiments of the invention and is not intended to limit the scope of the claims in any way. Indeed, the invention is broader than and unlimited by the exemplary embodiments, and the terms used in the claims have their full ordinary meaning. Features and components of one exemplary embodiment may be incorporated into the other exemplary embodiments. Inventions within the scope of this application may include additional features, or may have less features, than those shown in, and described in connection with, the exemplary embodiments.

As described herein, the terms “substantially” and “about” are defined as at least close to (and includes) a given value or state (preferably within 10% of, more preferably within 1% of, and most preferably within 0.1% of a given value or state).

Window assemblies described in the present application provide for a drop-in, universal design that can be used with a garage door or other surface having any thickness. In various examples, the window assemblies of the present application can include interior and exterior frame elements, where each frame element includes an inner engagement portion that is aligned with a window glazing of the window assembly. The length of the inner engagement portion of the exterior frame element can remain constant regardless of the thickness of the door or other surface to which the window assembly is attached, and the length of the inner engagement portion of the interior frame element can be based on the thickness of the door or other surface to which the window assembly is attached. The interior and exterior frame elements can be made by injection molding. In various implementations, the interior and exterior frame elements can be made using the same mold.

In some examples, the window assemblies described herein can include an impact element that provides impact resistance to the window assembly. The impact element can be easily attached to the exterior frame elements described herein and positioned to be disposed between the interior frame element and the window glazing. In some examples, one or both of the interior and exterior frame elements can have ribs and/or slots that correspond to channels or ribs of the garage door or other surface to which the window assembly is attached, where the ribs/slots provide a scaling arrangement between the garage door or other surface and the window assembly.

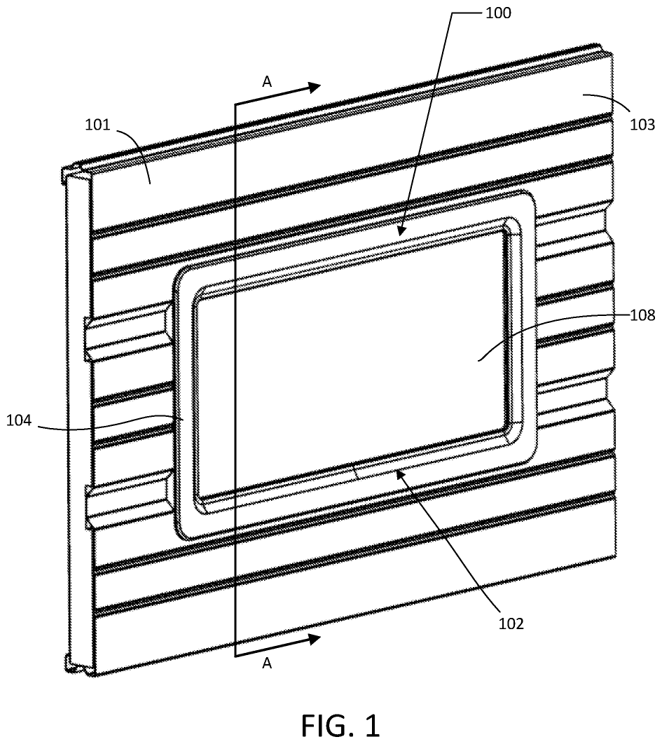

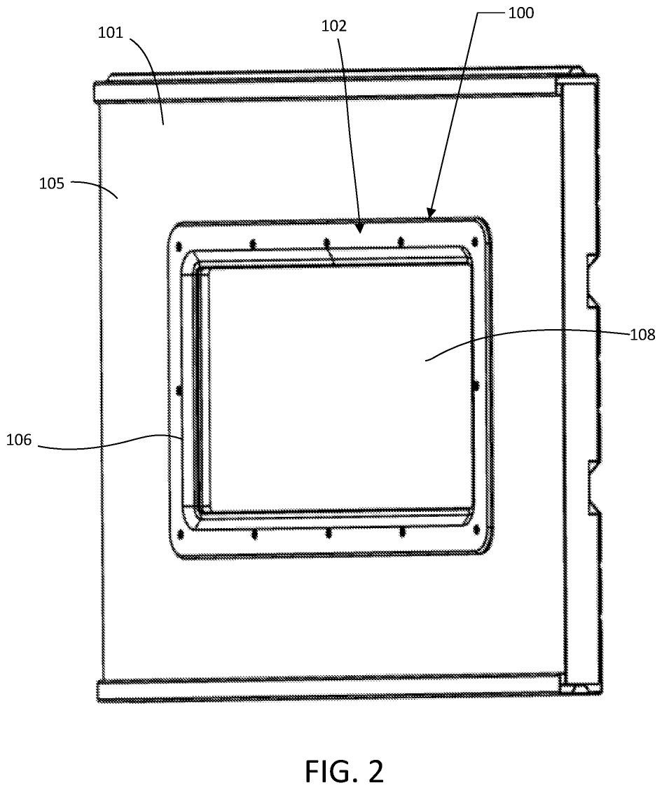

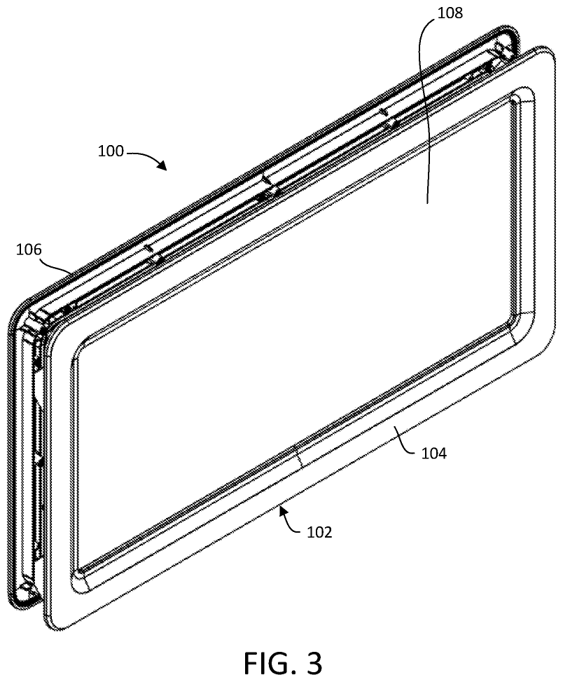

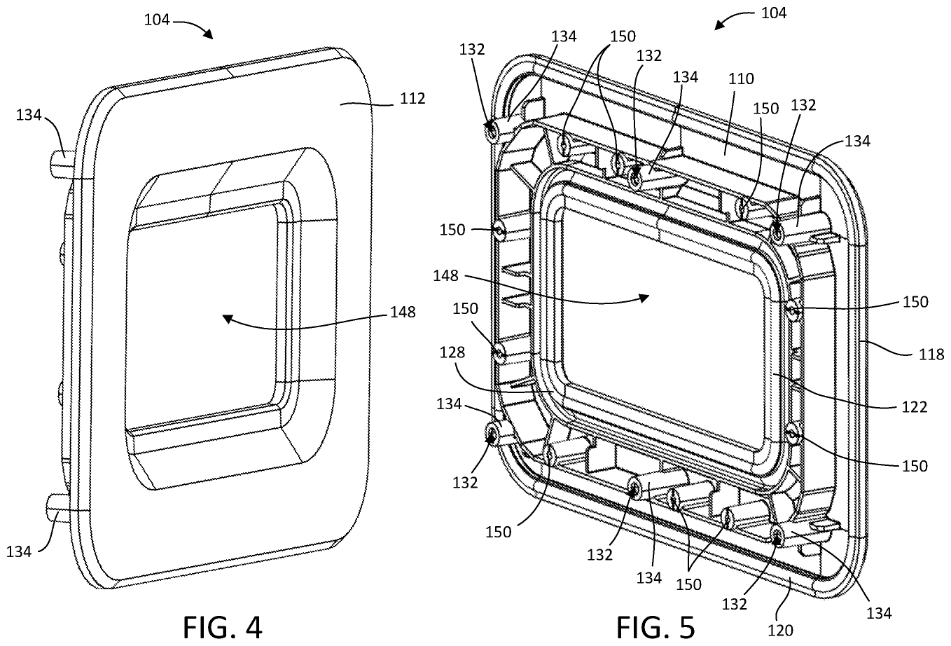

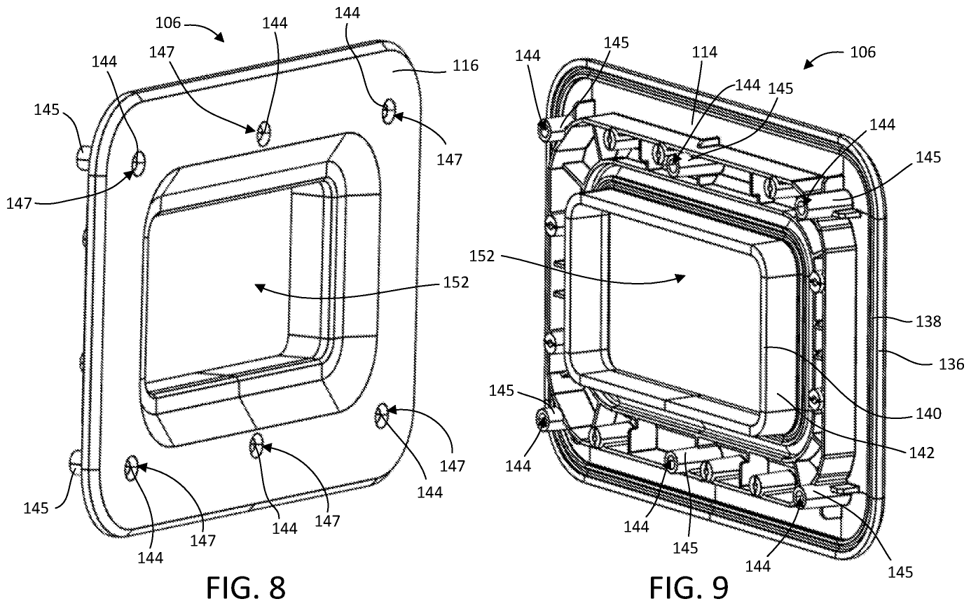

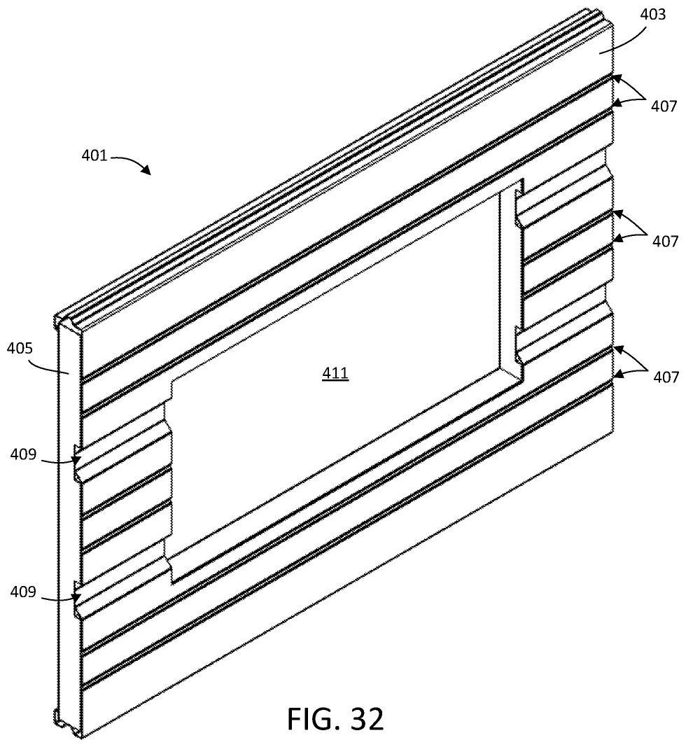

FIGS. 1 through 14 illustrate an example window assembly 100 for attaching to a garage door 101. The window assembly 100 includes a frame 102 that includes an exterior frame element 104 and an interior frame element 106 that are configured to be attached together and secure a window glazing 108 (e.g., a laminated glass panel, a polycarbonate panel, etc.) to the garage door 101. Referring to FIG. 1, the exterior frame element 104 is positioned within an opening (e.g., opening 411 shown in FIG. 32) and sized larger than the opening such that an internal portion 110 (FIGS. 5-7) of the exterior frame element 104 abuts an exterior surface 103 of the garage 101. The exterior frame element 104 has an external portion 112 (FIG. 4) that is visible from an exterior of the garage 101. The exterior portion 112 can take any suitable shape, such as, for example, any shape shown and/or described in the present application. Referring to FIG. 2, the interior frame element 106 is positioned within the opening (e.g., opening 411 shown in FIG. 32) and sized larger than the opening such that an internal portion 114 (FIGS. 9-11) of the interior frame element 106 abuts an interior surface 105 of the garage 101. The interior frame element 106 has an external portion 116 (FIG. 8) that is visible from an interior of the garage 101. The external portion 116 can take any suitable shape, such as, for example, any shape shown and/or described in the present application.

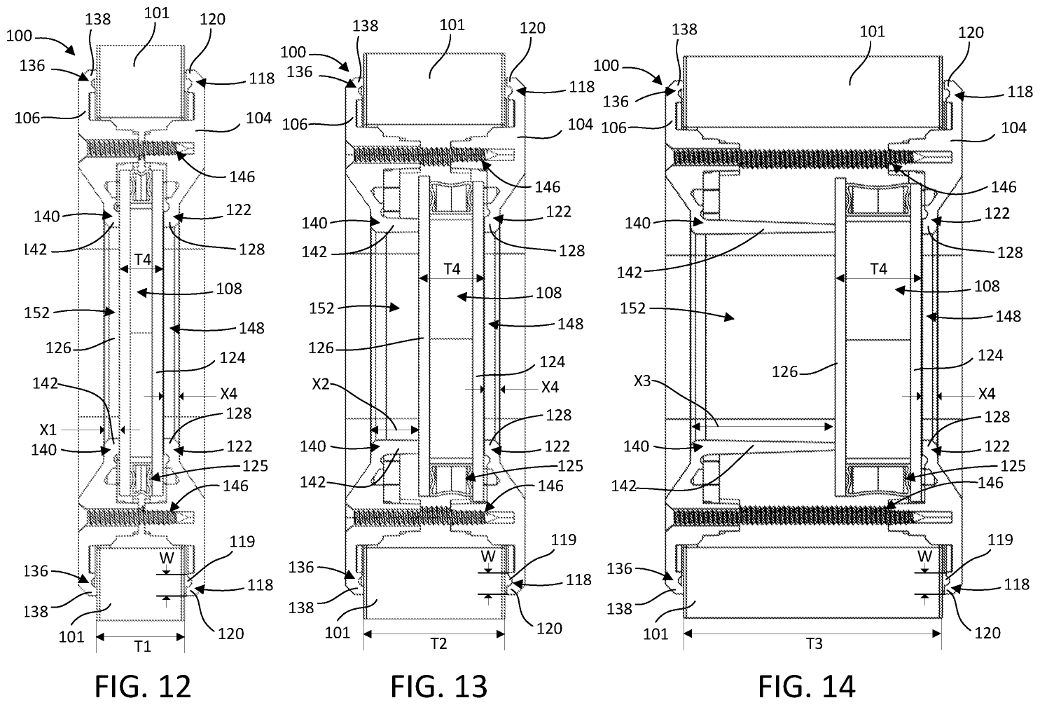

Referring to FIGS. 4-7, the exterior frame element 104 can include an outer engagement portion 118 for engaging the garage door 101 (as shown in FIGS. 12-14) when the exterior frame element 104 is attached to the garage door 101. In various implementations, the outer engagement portion 118 is configured to provide a sealing engagement with the garage door 101 to inhibit outside elements from entering the garage through the window assembly 100. For example, a sealing material 119 (FIGS. 12-14) can be used to provide a sealing engagement between the outer engagement portion 118 and the garage door 101. The sealing material 119 can be, for example, a foam hot melt sealant or the like. In some examples, the outer engagement portion 118 includes one or more protruding members 120 (as shown in FIGS. 5-6 and 12-14). The outer engagement portion 118 can extend continuously around the internal portion 110 of the exterior frame element 104. In other examples, the outer engagement portion 118 can include two or more members that extend intermittently around the internal portion 110 of the exterior frame element 104. In the illustrated example, the outer engagement portion 118 is positioned proximate an outer edge of the exterior frame element 104. However, it should be understood that the outer engagement portion 118 can be positioned at any suitable location of the exterior frame element 104 that allows for the outer engagement portion 118 to engage the garage door 101 when the window assembly 100 is installed on the garage door 101.

The exterior frame element 104 can include an inner engagement portion 122 for engaging the window glazing 108. In some implementations, as shown in FIGS. 12-14, the window glazing 108 can include an outer pane 124 and an inner pane 126 that are spaced apart by a spacer 125 such that the window glazing 108 is insulated, and the engagement portion 122 can be configured to engage the outer pane 124. In various implementations, the inner engagement portion 122 is configured to provide a scaling engagement with the window glazing 108 to inhibit outside elements from entering the garage through the window assembly 100. For example, a scaling material (e.g., a foam hot melt sealant or the like) can be used to provide a sealing engagement between the inner engagement portion 122 and the window glazing 108. In some examples, the inner engagement portion 122 includes one or more protruding members 128 (as shown in FIGS. 5-6 and 12-14). The inner engagement portion 122 can extend continuously around the internal portion 110 of the exterior frame element 104. In other examples, the inner engagement portion 122 can include two or more members that extend intermittently around the internal portion 110 of the exterior frame element 104. In various implementations, the inner engagement portion 122 can define an exterior viewing channel 148 that extends to the window glazing 108 (as shown in FIGS. 12-14).

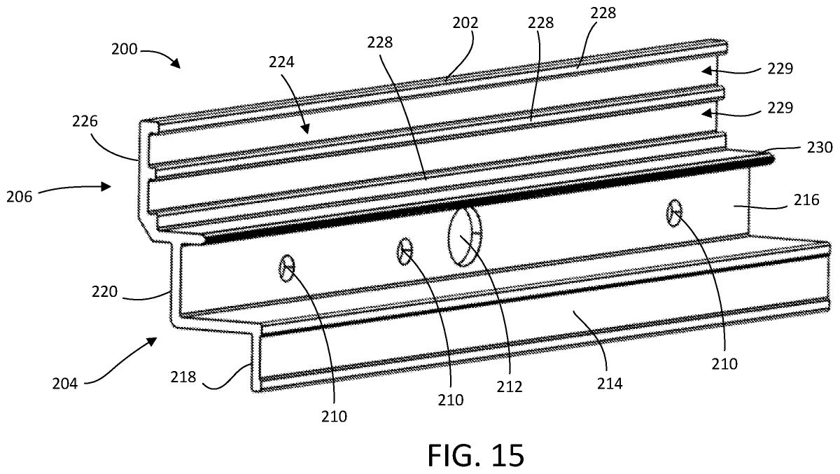

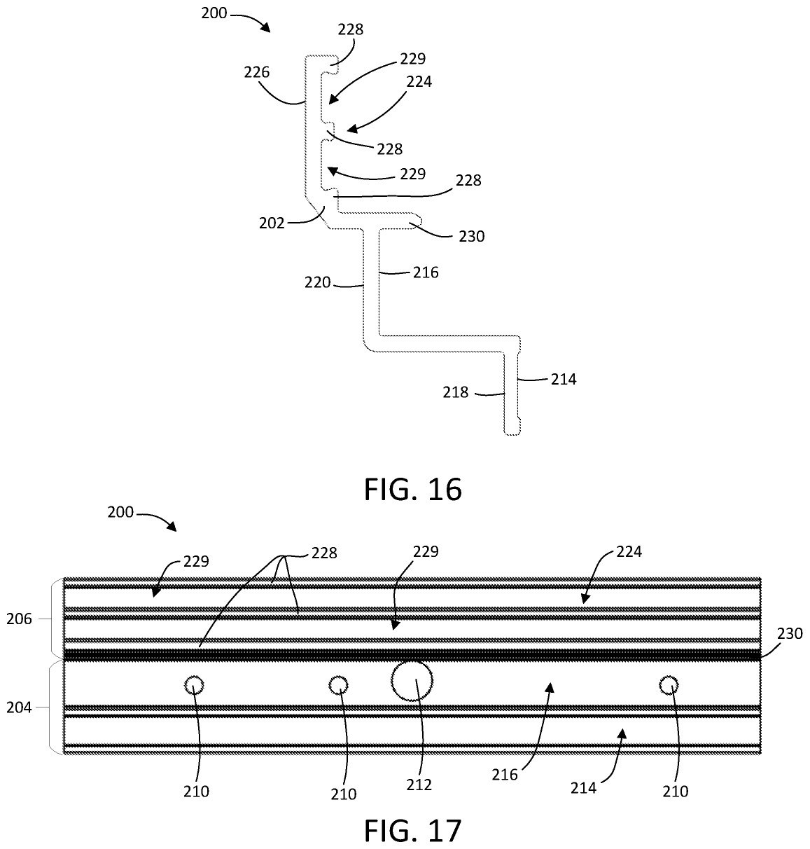

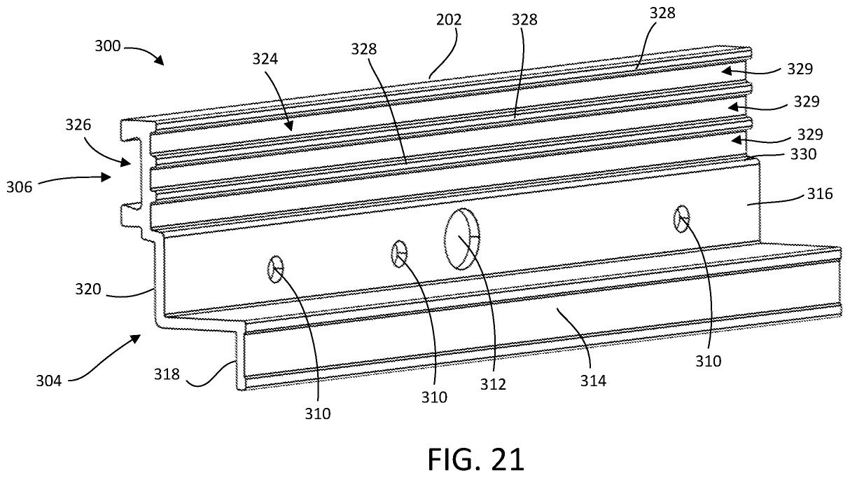

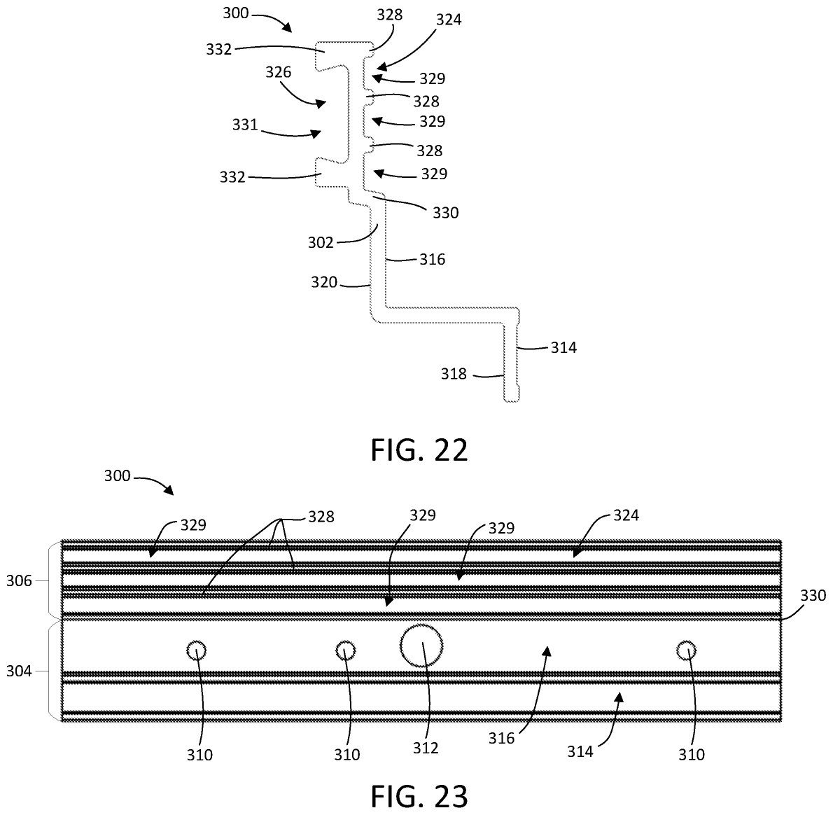

Still referring to FIGS. 4-7, the exterior frame element 104 can include a plurality of openings 132 that are configured to receive fasteners (e.g., screws) for attaching the exterior frame element 104 to the interior frame element 106. In the illustrated example, each of the openings 132 are defined by a protruding element 134 that extends from the internal portion 110 of the exterior frame element 104. In various examples, the openings 132 can be threaded and configured to receive a threaded fastener. In some examples, the exterior frame element can include a plurality of openings 150 that are configured to receive fasteners (e.g., screws) for attaching an impact element (e.g., impact element 200 shown in FIGS. 15-20, impact element 300 shown in FIGS. 21-26, or any other suitable impact element) to the internal portion 110 of the exterior frame element 104.

The exterior frame element 104 can be made by any suitable means, such as, for example, any means described in the present application. In various implementations, the exterior frame element 104 is made by injection molding. In these implementations, each of the components of the exterior frame element 104 can be integrally connected to each other. In various examples, the inner engagement portion 122 can be integrally formed with the internal surface 110 of the exterior frame element 104. The exterior frame element 104 can be made of, for example, acrylonitrile styrene acrylate (ASA), acrylonitrile butadiene styrene (ABS), filled polypropylene (e.g., which can include fillers such as glass, calcium, and/or other any other suitable material), and/or any other suitable material.

Referring to FIGS. 8-11, the interior frame element 106 can include an outer engagement portion 136 for engaging the garage door 101 (as shown in FIGS. 12-14) when the interior frame element 106 is attached to the garage door 101. In various implementations, the outer engagement portion 136 is configured to provide a sealing engagement with the garage door 101 to inhibit outside elements from entering the garage through the window assembly 100. For example, a sealing material (e.g., a foam hot melt sealant or the like) can be used to provide a sealing engagement between the outer engagement portion 136 and the garage door 101. In some examples, the outer engagement portion 136 includes one or more protruding members 138 (as shown in FIGS. 9-10 and 12-14). The outer engagement portion 136 can extend continuously around the internal portion 114 of the interior frame element 106. In other examples, the outer engagement portion 136 can include two or more members that extend intermittently around the internal portion 114 of the interior frame element 106. In the illustrated example, the outer engagement portion 136 is positioned proximate an outer edge of the interior frame element 106. However, it should be understood that the outer engagement portion 136 can be positioned at any suitable location of the interior frame element 106 that allows for the outer engagement portion 136 to engage the garage door 101 when the window assembly 100 is installed on the garage door 101.

The interior frame element 106 can include an inner engagement portion 140 for engaging the window glazing 108. In some implementations, as shown in FIGS. 12-14, the window glazing 108 can include an outer pane 124 and an inner pane 126, and the engagement portion 140 can be configured to engage the inner pane 126. In various implementations, the inner engagement portion 140 is configured to provide a scaling engagement with the window glazing 108 to inhibit outside elements from entering the garage through the window assembly 100. In some examples, the inner engagement portion 140 includes one or more protruding members 142 (as shown in FIGS. 9-10 and 12-14). The inner engagement portion 140 can extend continuously around the internal portion 114 of the interior frame element 106. In other examples, the inner engagement portion 140 can include two or more members that extend intermittently around the internal portion 114 of the interior frame element 106. In various implementations, the inner engagement portion 140 can define an interior viewing channel 152 that extends to the window glazing 108 (as shown in FIGS. 12-14).

Still referring to FIGS. 8-11, the interior frame element 106 can include a plurality of openings 144 that are configured to receive fasteners (e.g., screws) for attaching the interior frame element 106 to the exterior frame element 104. In the illustrated example, each of the openings 144 are defined by a protruding element 145 that extends from the internal portion 114 of the interior frame element 106. The openings 144 of the interior frame element 106 are positioned to align with the openings 132 of the exterior frame element 104 such that a fasteners can extend through each of the aligned openings 132, 144 to secure the interior frame element 106 to the exterior frame element 104. In the illustrated example, the openings 144 extend entirely through the interior frame element 106 such that an insertion portion 147 for inserting a fastener into the opening 144 can be disposed on the external surface 116 of the interior frame element 106. This allows a user to insert fasteners into the openings 144 of the interior frame element 106 and the aligned openings 132 of the exterior frame element 104 to secure the interior frame element 106 to the exterior frame element 104. In various examples, the openings 144 can be threaded and configured to receive a threaded fastener.

The interior frame element 106 can be made by any suitable means, such as, for example, any means described in the present application. In various implementations, the interior frame element 106 is made by injection molding. In these implementations, each of the components of the interior frame element 106 can be integrally connected to each other. In various examples, the inner engagement portion 140 can be integrally formed with the internal surface 114 of the interior frame element 106. The interior frame element 106 can be made of, for example, acrylonitrile styrene acrylate (ASA), acrylonitrile butadiene styrene (ABS), filled polypropylene (e.g., which can include fillers such as glass, calcium, and/or other any other suitable material), and/or any other suitable material.

Referring to FIGS. 3 and 12-14, the exterior frame element 104 and the interior frame element 106 are configured to be connected to form the frame 102. Referring to FIGS. 12-14, the openings 144 of the interior frame element 106 and the openings 132 of the exterior frame element 104 can be aligned when the frame elements 104, 106 are positioned within an opening of the garage door 101 (e.g., opening 411 shown in FIG. 32), and a fastener 146 can be inserted into each opening 144 of the interior frame element 106 and a corresponding opening 132 of the exterior frame element 104 to connect the frame elements 104, 106 together such that the frame 102 is attached to the garage door 101 with a window glazing 108 positioned between the frame element 104, 106. The exterior frame element 104 and interior frame element 106 can be attached to the garage door 101 by a clamped connection with the garage door 101 (e.g., via the engagement between the outer engagement portions 118, 136 of each frame element 104, 106 and the garage door 101) due to the force exerted on the frame elements 104, 106 by the fasteners 146. In some instances, an adhesive or other suitable fastener can assist in connecting the frame elements 104, 106 to the garage door 101. The window glazing 108 can be secured between the exterior frame element 104 and interior frame element 106 by a clamped connection (e.g., via the engagement between the inner engagement portions 122, 140 of each frame element 104, 106 and the window glazing 108) due to the force exerted on the frame elements 104, 106 by the fasteners 146. In some instances, an adhesive or other suitable fastener can assist in securing the window glazing 108 between the frame elements 104, 106.

In the illustrated example, the openings 144 of the interior frame element 106 extend through the external surface 116 (as shown in FIG. 8) such that a user can insert the fasteners 146 from an interior side of the garage door 101 and through both the openings 144 of the interior frame element 106 and the openings 132 of the exterior frame element 106 when installing the window assembly 100. In various examples, the openings 132 of the exterior frame element 104 do not extend through the external surface 112 of the exterior frame element 104 so that the fasteners 144 are not visible from an exterior of the garage door 101 when the window assembly is installed. However, it should be understood that the openings 132, 144 can take any suitable form and be positioned at any location on the frame elements 104, 106 that allow for the frame elements 104, 106 to be connected together and secured to the garage door 101. While the illustrated example shows the exterior and interior frame elements 104, 106 being connected by fasteners 146, it should be understood that the frame elements 104, 106 can be connected by any other suitable means, such as, for example, an adhesive connection, a snap-fit connection, etc.

In various examples, the inner engagement portion 140 of the interior frame element 106 can be configured to allow the frame 102 to be used with garage doors 101 having various sized thicknesses (e.g., thicknesses T1-T3), and inner engagement portion 122 of the exterior frame element 104 can be constant regardless of the thickness of the garage door 101. In particular, referring to FIGS. 12-14, the length (e.g., lengths X1-X3) of the inner engagement portion 140 can be determined based on the thickness T1-T3 of the garage door 101. For example, the thickness T3 of the garage door 101 shown in FIG. 14 is greater than the thickness T2 of the garage door 101 shown in FIG. 13, and the thickness T2 of the garage door 101 shown in FIG. 13 is greater than the thickness T1 of the garage door 101 shown in FIG. 12. In these examples, the length X3 of the inner engagement portion 140 of the interior frame element 106 shown in FIG. 14 is greater than the length X2 of the inner engagement portion 140 shown in FIG. 13, and the length X2 of the inner engagement portion 140 shown in FIG. 13 is greater than the length X1 of the inner engagement portion 140 shown in FIG. 12. In these examples, the length X4 of the inner engagement portion 122 of the exterior frame element 104 is substantially equal for each of the window assemblies 100 shown in FIGS. 12-14. In the examples shown in FIG. 12-14, the thickness T1-T3 of the garage door 101 corresponds to the length X1-X3 of the inner engagement portion 140 of the interior frame element 106.

In various examples, the length X1-X3 of the inner engagement portion 140 of the interior frame element 106 can define the length of the interior viewing channel 152, and the length X4 of the inner engagement portion 122 of the exterior frame element 104 can define the length of the exterior viewing channel 148. Referring to FIG. 12, the length X1 of the inner engagement portion 140 is substantially equal to the length X4 of the inner engagement portion 122. Still referring to FIG. 12, the length of the interior viewing channel 152 is substantially equal to the length of the exterior viewing channel 148. Referring to FIGS. 13 and 14, the lengths X2, X3 of the inner engagement portion 140 are each greater than the length X4 of the inner engagement portion 122. Still referring to FIGS. 13 and 14, the lengths of the interior viewing channel 152 based on each of the lengths X2, X3 of the inner engagement portion 140 is greater than the length of the exterior viewing channel 148.

In various implementations, the length X1-X3 of the inner engagement portion 140 of the interior frame element 140 can be determined based on the thickness T4 (FIGS. 12-14) of the window glazing 108. The determination of the length X1-X3 can be based on the thickness T4 of the window glazing 108 alone, or the thickness T4 of the window glazing 108 in combination with the thickness T1-T3 of the garage door 101.

While the illustrated examples show the length X1-X3 of the inner engagement portion 140 of the interior frame element 106 being adjusted based on the thickness T1-T3 of the garage door 101, and the length X4 of the inner engagement portion 122 of the exterior frame element 104 being constant regardless of the thickness T1-T3 of the garage door 101, in other implementations, it should be understood that the length X4 of the inner engagement portion 122 of the exterior frame element 104 can be adjusted based on the thickness of the garage door 101 and the length of the inner engagement portion 140 of the interior frame element 104 can be constant regardless of the thickness T1-T3 of the garage door 101. In addition, while the illustrated examples show the length of the interior viewing channel 152 being adjusted based on the thickness T1-T3 of the garage door 101, and the length of the exterior viewing channel 148 remains constant, it should be understood that the length of the exterior viewing channel could be adjusted based on the thickness T1-T3 of the garage door and the length of the interior viewing channel 152 could remain constant.

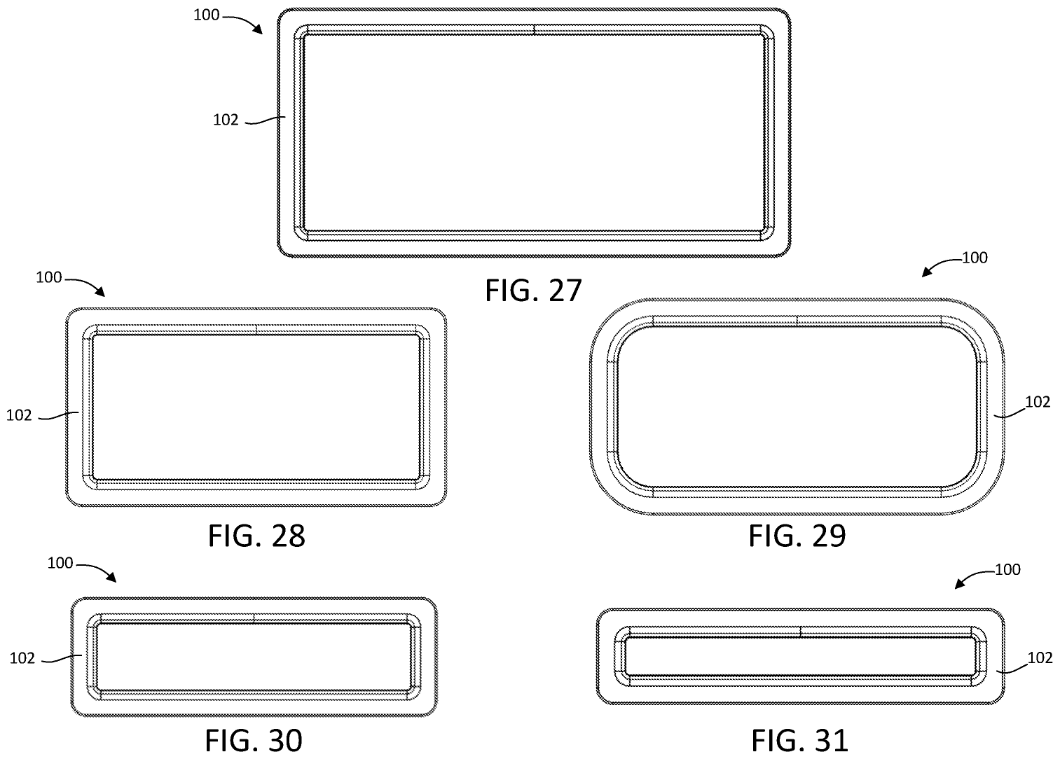

FIGS. 27-31 illustrate various sizes and shapes for frame 102 of the window assembly 100. While FIGS. 27-31 illustrate various sizes and shapes for the frame 102, it should be understood that the frame 102 can have any other suitable shape and/or size to fit the needs of the user.

FIGS. 15-20 illustrate an example impact element 200 that can be used with a window assembly (e.g., the window assembly 100 described in the present application) to provide impact resistance to the window assembly. In various implementations, the impact element 200 can be configured to inhibit damage to the window assembly during an impact event (e.g., high winds resulting from a hurricane or tornado), as well as protect against debris that may strike the window assembly due to such impact event. For example, the impact element 200 can be configured such that a window assembly that includes the impact element 200 allows for a garage door to which the window assembly is attached to be impact rated (e.g., in accordance with the ANSI/DASMA 115, Section 8.6 standard; the Florida Testing Application Standard 201-94; and/or the Florida Testing Application Standard 203-94). The impact element 200 will be described with reference to the window assembly 100 described with reference to FIGS. 1-14, but it should be understood that the impact element 200 can be used with any other suitable window assembly.

The impact element 200 can have a body 202 that includes a first portion 204 and a second portion 206. The first portion 204 can be configured to be secured to the exterior frame element 104 of the window assembly 100. For example, the first portion 204 can include openings 210 for receiving fasteners 222 (e.g., screws), where the openings 210 are configured to align with corresponding openings 150 on the internal surface 110 of the exterior frame element 104 such that one or more fasteners can be inserted through the openings 210 of the impact element 200 and the openings 150 of the exterior frame element 104 to secure the impact element 200 to the exterior frame element 104. The first portion 204 can include one or more openings 212 that allow for the protruding element(s) 134 of the exterior frame element 104 to extend therethrough such that the openings 132 of the exterior frame element 104 can be aligned with the openings 144 of the interior frame element 106 to secure the interior frame element 106 to the exterior frame element 104. In some implementations, a glazing adhesive can be used to secure the impact element 200 to the exterior frame element 104. For example, a glazing adhesive can be positioned at one or more of a front engagement surface 214, channel(s) 229, and proximate a protrusion 228 of the impact element 200 to secure the impact element 200 to the exterior frame element 104.

In the illustrated example, the first portion 204 includes a first front engagement surface 214 and a second front engagement surface 216. The first front engagement surface 214 can be configured to engage the internal surface 110 of the exterior frame element 104, and the second front engagement surface 214 can be configured to engage a surface of the exterior frame element 104 that includes openings 150. While the illustrated example shows the first portion 204 having two front engagement surface 214, 216, it should be understood that the first portion 204 can have any suitable number of front engagement surfaces that allows for the first portion 204 to be secured to an exterior frame element 104 and engage the internal surface of the exterior frame element between the outer engagement element 118 and the window glazing 108.

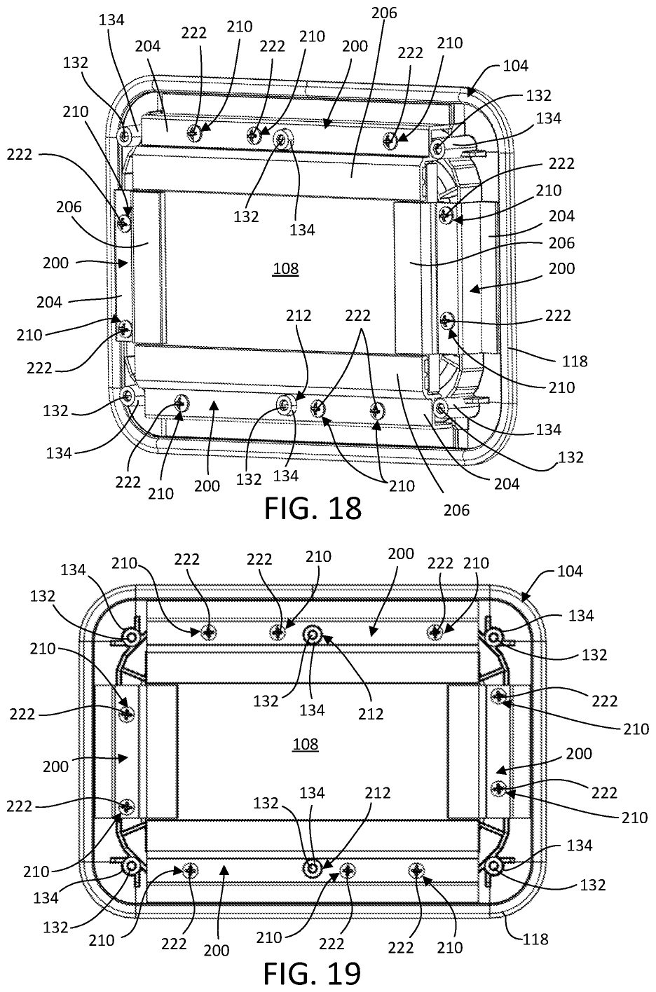

In the illustrated example, the first portion 204 includes a first rear engagement surface 218 and a second rear engagement surface 220. The first rear engagement surface 218 can be configured to engage the garage door 101 when the window assembly 100 is secured to the garage door 101, and the second rear engagement surface 220 can be configured to be engaged by fastener(s) 222 (FIGS. 18-20) for securing the impact element 200 to the exterior frame element 104. In some implementation, first rear engagement surface 218 can be configured to attach to the garage door by an adhesive 219 (e.g., a double-sided tape or any other suitable type of adhesive). The adhesive 219 can assist in attaching the exterior frame element 104 to the garage door 101 and/or assist in sealing the exterior frame element 104 to the garage door 101 to prevent outside elements from entering an interior of the garage. While the illustrated example shows the first portion 204 having two rear engagement surface 218, 220, it should be understood that the first portion 204 can have any suitable number of rear engagement surfaces that allows for the first portion 204 to engage the garage door 101 and receive fastener(s) 222 for securing the first portion 204 to the exterior frame element 104.

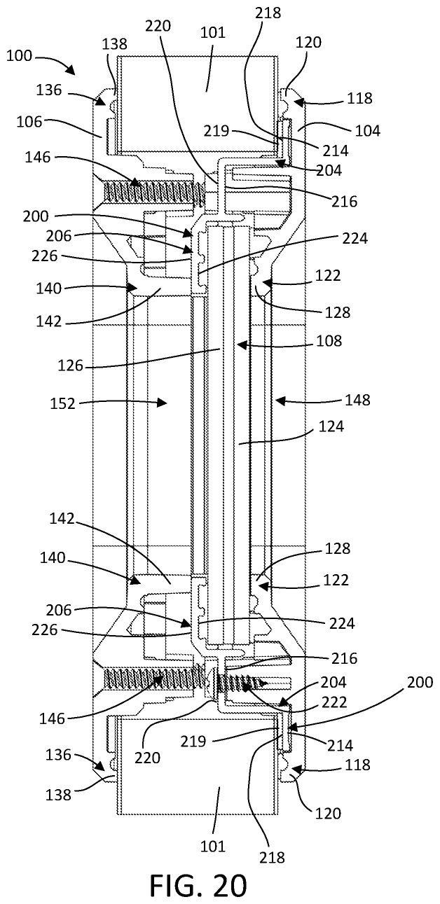

The second portion 206 of the impact element 200 can be configured to engage the window glazing 108 and the interior frame element 106 of the window assembly (as shown in FIG. 20). In the illustrated example, the second portion 206 includes a front engagement surface 224 and a rear engagement surface 226. The front engagement surface 224 can be configured to engage the window glazing 108. In some examples, the front engagement surface 224 can include one or more protrusions 228 for engaging the window glazing 108 with channels 229 positioned therebetween. The channels 229 can be configured to allow for an adhesive to be positioned therein, and the depth of the channels 229 can allow for the adhesive to absorb impact. While the illustrated example shows the front engagement surface 224 having two channels 229, it should be understood that the front engagement surface 224 can have any suitable number of channels 229, such as one or more channels, two or more channels, three or more channels, etc. It should also be understood that one or more of these channels can include an adhesive for adhering the front engagement surface 224 to the window glazing 108 and/or absorbing impact. In some implementations, an adhesive can be positioned on front surface of the protrusion 228 that is positioned proximate extended member 230, where the adhesive can be configured to adhere the front engagement surface 224 to the window glazing 108 and/or absorb impact. The rear engagement surface 226 can be configured to be engaged by the interior frame element 106. For example, the rear engagement surface 226 can be configured to be engaged by the inner engagement element 140 of the interior frame element 106 (as shown in FIG. 20).

In some implementations, the rear engagement surface 326 can include one or more optional protrusions (not shown) for engaging the interior frame element 106 (e.g., similar to the protrusions 332 for the impact element 300 described in the present application), where the optional protrusions can have one or more channels positioned therebetween. The use of the protrusions and the size of the protrusions depends on the amount of space in the window assembly 100 in which the impact element 200 is to occupy. For example, for window assemblies 100 that include a thinner window glazing 108, the impact element 200 can include protrusions such that the protrusions can be positioned to engage the interior frame element 106. For window assemblies 100 that include a thicker window glazing 108, limited space may exist between the impact element 300 and the interior frame element 106 and, in these situations, the impact element 200 may not include protrusions because the space between the impact element 200 and the interior frame element 106 does not require such protrusions.

In some implementations, the impact element 200 can include an extended member 230 that extends below the window glazing 108. The extended member 230 can be positioned below the window glazing 108 such that the extended member can inhibit the window glazing from shifting during assembly of the window assembly 100. In some implementations, the extended member 230 can be configured to allow for an adhesive to be applied to the front surface of the protrusion 228 that is proximate the extended member 230. The extended member 230 can be configured to act as a guiding feature for the impact element 200 when securing the impact element 200 to the exterior frame element 104. For example, the extended member 230 can act as a guiding feature between the openings 132 of the exterior frame element 104 and the window glazing 108 prior to the impact element 200 being installed on the exterior frame element 104.

The impact element 200 can be made by injection molding or any other suitable means. The impact element 200 can be made of aluminum, carbon fiber, fiberglass, formed steel, and/or any other suitable materials. In various implementations, the impact element 200 is a single piece of material.

The impact element 200 provides impact resistance to the window assembly 100 by providing reinforcement to the exterior frame element 104. The impact element 200 can be configured stiffen the window assembly 100 and transfer the impact loading of the window glazing 108 to an exterior surface of the door to which the window assembly 100 is attached. For example, the first rear engagement portion 218 of the first portion 204 of the impact element 200 can be configured to engage the door to which the window assembly 100 is attached and transfer the impact loading of the window glazing 108 to the door. The impact element 200 can be configured to absorb a majority of the force being applied by an impact event. The impact element 200 of the window assembly 100 in the illustrated example is advantageous because it absorbs a majority of the force being applied by the impact event while being positioned behind the exterior frame element 104 of the window assembly 100.

Referring to FIGS. 18-19, the window assembly 100 includes an exterior frame element 104 with four impact elements 200 attached thereto. For example, an impact element 200 can be attached at each side of the rectangular shaped exterior frame element 104. However, it should be understood that an exterior frame element 104 can have any suitable shape, and any suitable number of impact elements 200 can be used to provide impact resistance to the window assembly 100.

FIGS. 21-26 illustrate an example impact element 300 that can be used with a window assembly (e.g., the window assembly 100 described in the present application) to provide impact resistance to the window assembly. For example, the impact element 300 can be configured to inhibit damage to the window assembly during an impact event (e.g., high winds resulting from a hurricane or tornado), as well as protect against debris that may strike the window assembly due to such impact event. For example, the impact element 300 can be configured such that a window assembly that includes the impact element 300 allows for a garage door to which the window assembly is attached to be impact rated (e.g., in accordance with the ANSI/DASMA 115, Section 8.6 standard; the Florida Testing Application Standard 201-94; and/or the Florida Testing Application Standard 203-94). The impact element 300 will be described with reference to the window assembly 100 described with reference to FIGS. 1-14, but it should be understood that the impact element 300 can be used with any other suitable window assembly.

The impact element 300 can have a body 302 that includes a first portion 304 and a second portion 306. The first portion 304 can be configured to be secured to the exterior frame element 104 of the window assembly 100. For example, the first portion 304 can include openings 310 for receiving fasteners 322 (e.g., screws), where the openings 310 are configured to align with corresponding openings 150 on the internal surface 110 of the exterior frame element 104 such that one or more fasteners can be inserted through the openings 310 of the impact element 300 and the openings 150 of the exterior frame element 104 to secure the impact element 300 to the exterior frame element 104. The first portion 304 can include one or more openings 312 that allow for the protruding element(s) 134 of the exterior frame element 104 to extend therethrough such that the openings 132 of the exterior frame element 104 can be aligned with the openings 144 of the interior frame element 106 to secure the interior frame element 106 to the exterior frame element 104.

In the illustrated example, the first portion 304 includes a first front engagement surface 314 and a second front engagement surface 316. The first front engagement surface 314 can be configured to engage the internal surface 110 of the exterior frame element 104, and the second front engagement surface 314 can be configured to engage a surface of the exterior frame element 104 that includes openings 150. While the illustrated example shows the first portion 204 having two front engagement surface 314, 316, it should be understood that the first portion 304 can have any suitable number of front engagement surfaces that allows for the first portion 304 to be secured to an exterior frame element 104 and engage the internal surface of the exterior frame element between the outer engagement element 118 and the window glazing 108.

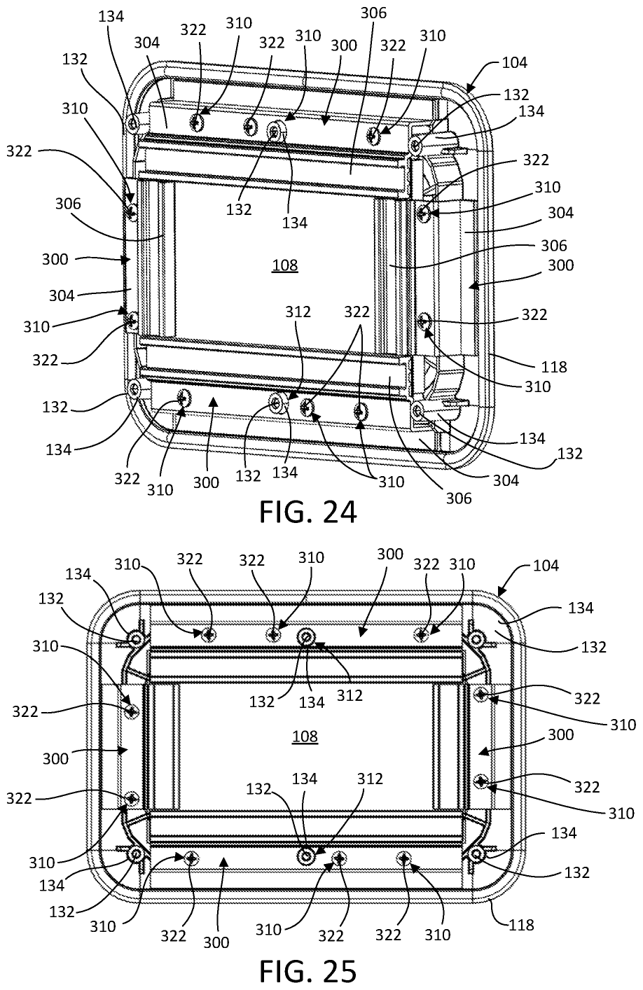

In the illustrated example, the first portion 304 includes a first rear engagement surface 318 and a second rear engagement surface 320. The first rear engagement surface 318 can be configured to engage the garage door 101 when the window assembly 100 is secured to the garage door 101, and the second rear engagement surface 320 can be configured to be engaged by fastener(s) 322 (FIGS. 24-26) for securing the impact element 300 to the exterior frame element 104. In some implementation, first rear engagement surface 318 can be configured to attach to the garage door by an adhesive 319 (e.g., a double-sided tape or any other suitable type of adhesive). The adhesive 319 can assist in attaching the exterior frame element 104 to the garage door 101 and/or assist in sealing the exterior frame element 104 to the garage door 101 to prevent outside elements from entering an interior of the garage. While the illustrated example shows the first portion 304 having two rear engagement surface 318, 320, it should be understood that the first portion 304 can have any suitable number of rear engagement surfaces that allows for the first portion 304 to engage the garage door 101 and receive fastener(s) 322 for securing the first portion 304 to the exterior frame element 104.

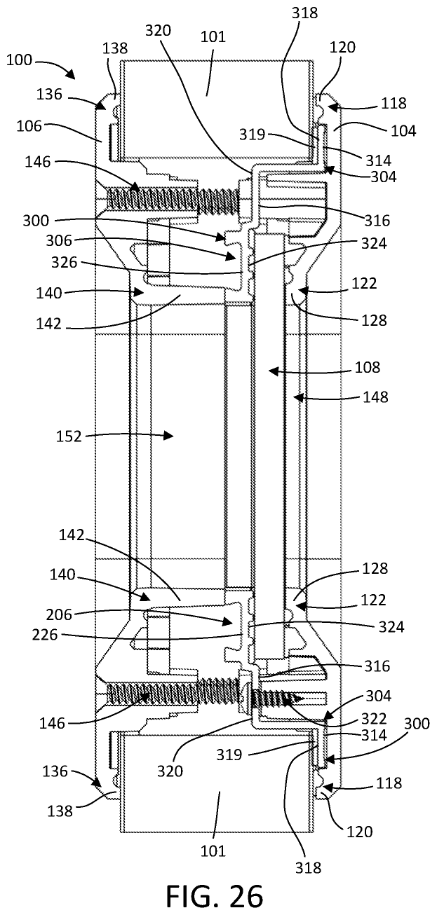

The second portion 306 of the impact element 300 can be configured to engage the window glazing 108 and the interior frame element 106 of the window assembly (as shown in FIG. 20). In the illustrated example, the second portion 306 includes a front engagement surface 324 and a rear engagement surface 326. The front engagement surface 324 can be configured to engage the window glazing 108. In some examples, the front engagement surface 324 can include one or more protrusions 328 for engaging the window glazing 108 with channels 329 positioned therebetween. The channels 329 can be configured to allow for an adhesive to be positioned therein, and the depth of the channels 329 can allow for the adhesive to absorb impact. While the illustrated example shows the front engagement surface 324 having three channels 329, it should be understood that the front engagement surface 324 can have any suitable number of channels 329, such as one or more channels, two or more channels, three or more channels, etc. It should also be understood that one or more of these channels can include an adhesive for adhering the front engagement surface 324 to the window glazing 108 and/or absorbing impact. The rear engagement surface 326 can be configured to be engaged by the interior frame element 106. For example, the rear engagement surface 326 can be configured to be engaged by the inner engagement element 140 of the interior frame element 106 (as shown in FIG. 26).

The rear engagement surface 326 can include one or more optional protrusions 332 for engaging the interior frame element 106, where the optional protrusions 332 can have one or more channels 331 positioned therebetween. The use of the protrusions 332 and the size of the protrusions 332 depends on the amount of space in the window assembly 100 in which the impact element 300 is to occupy. For example, for window assemblies 100 that include a thinner window glazing 108, the impact element 300 can include protrusions 332 such that the protrusions 332 can be positioned to engage the interior frame element 106. For window assemblies 100 that include a thicker window glazing 108, limited space may exist between the impact element 300 and the interior frame element 106 and, in these situations, the impact element 300 may not include protrusions 332 because the space between the impact element 300 and the interior frame element 106 does not require such protrusions.

In some implementations, the impact element 300 can include a transition portion 330 that separates the first and second portions 304, 306. The transition portion 330 is configured to allow the front engagement surface 324 to be positioned to engage the window glazing 108 when the impact element 300 is attached to the exterior frame element 104. While the impact element 300 is not shown as having an extended member (e.g., similar to extended member 230 for the impact element 200 described in the present application), it should be understood that the impact element 300 has an extended member (e.g., proximate the transition portion 330) that is configured similar to the extended member 230 for the impact element 200 shown in FIGS. 15-20.

The impact element 300 can be made by injection molding or any other suitable means. The impact element 300 can be made of aluminum, carbon fiber, fiberglass, formed steel, and/or any other suitable materials. In various implementations, the impact element 300 is a single piece of material.

The impact element 300 provides impact resistance to the window assembly 100 by providing reinforcement to the exterior frame element 104. The impact element 300 can be configured stiffen the window assembly 100 and transfer the impact loading of the window glazing 108 to an exterior surface of the door to which the window assembly 100 is attached. For example, the first rear engagement portion 318 of the first portion 304 of the impact element 300 can be configured to engage the door to which the window assembly 100 is attached and transfer the impact loading of the window glazing 108 to the door. The impact element 300 can be configured to absorb a majority of the force being applied by an impact event. The impact element 300 of the window assembly 100 in the illustrated example is advantageous because it absorbs a majority of the force being applied by the impact event while being positioned behind the exterior frame element 104 of the window assembly 100.

Referring to FIGS. 24-25, the window assembly 100 includes an exterior frame element 104 with four impact elements 300 attached thereto. For example, an impact element 300 can be attached at each side of the rectangular shaped exterior frame element 104. However, it should be understood that an exterior frame element 106 can have any suitable shape, and any suitable number of impact elements 300 can be used to provide impact resistance to the window assembly 100.

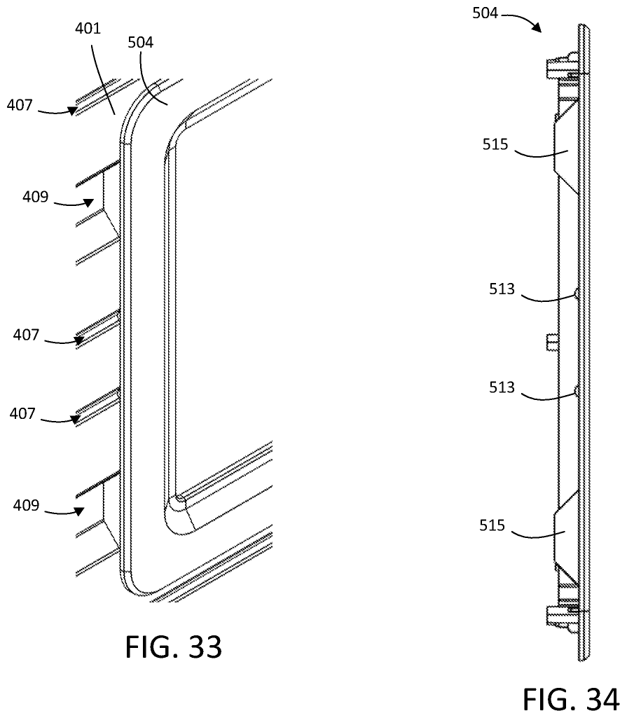

FIG. 32 illustrates an example garage door 401 having a frame 403 and insulation 405 disposed within the frame 403, where the frame has exterior channels 407, 409. The garage door 401 has an opening 411 for receiving a window assembly (e.g., window assembly 100 described in the present application). FIGS. 33-34 illustrate an example exterior frame element 504 for a window assembly that can be used for the garage door 401, where the exterior frame element 504 includes ribs 513, 515 that correspond to the channels 407, 409 of the garage door 401 such that the ribs 513, 515 provide a sealing arrangement with the garage door 401 to inhibit outside elements from moving through the window assembly and the opening 411 to enter an interior of the garage. The exterior frame element 504 can take any suitable form, such as, for example, any form of the exterior frame element 104 described in the present application. The exterior frame element 504 can be used with any suitable window assembly, such as, for example, any window assembly 100 described in the present application.

In the illustrated example, the garage door 401 includes first channels 407 having a first size and shape and second channels 409 having a second size and shape that are different than that of the first channels 407. The exterior frame element 504 can have first ribs 513 that correspond to the size and shape of the channels 407 of the garage door 401, and the exterior frame element 504 can have second ribs 515 that correspond to the size and shape of the channels 409 of the garage door 401. In the illustrated example, the ribs 513, 515 are positioned proximate an outer edge of the exterior frame element 504. In various examples, the ribs 513, 515 can be substantially aligned with a protruding member of an outer engagement portion of the exterior frame element 504 (e.g., similar to protruding member 120 of the outer engagement portion 118 of the exterior frame element 104 shown in FIGS. 5-6 and 12-14). In some examples, the ribs 513, 515 can be sized to have substantially the same width W (FIGS. 12-14) as the protruding member 120. In some examples, the ribs 513, 515 and the protruding member 120 can be integral with each other. In some examples, a sealing material (e.g., similar to sealing material 119 shown in FIGS. 12-14) can be applied to each of the protruding member 120 and the ribs 513, 515 to provide for a scaling engagement between the window assembly and the garage door 101. The sealing material can be, for example, a foam hot melt sealant or the like.

While the illustrated example shows the exterior frame element 504 having two first ribs 513 and two second ribs 515, it should be understood that the exterior frame element 504 can have any suitable number of first ribs 513 and second ribs 515 depending on the number of first and second channels 407, 409 that align with the opening 411 of the garage door 401. While the illustrated example shows the exterior frame element have two different types of ribs 513, 515, it should be understood that the exterior frame element 504 can have any number of different types of ribs depending on the different types of channels of the garage door 401 that align with the opening 411 of the garage door 401. The ribs 513, 515 can be positioned at any location on the exterior frame element 504 that allows for the ribs to align with corresponding channels on the garage door 401, and the ribs 513, 515 can take any suitable shape that corresponds to the shape of the corresponding channels. While the illustrated example only shows ribs 513, 515 on a first side of the exterior frame element 504, it should be understood that the other side of the exterior frame element 504 can have ribs 513, 515 that align with the corresponding channels 407, 409 of the garage door 401.

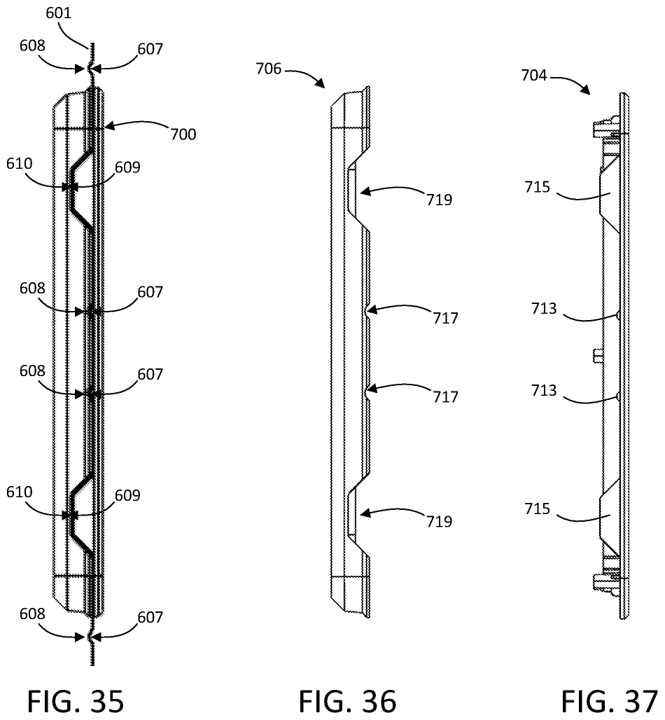

FIGS. 35-37 illustrate a window assembly 700 attached to a garage door 601, where the garage door 601 has a frame 603 (without insulation) that includes exterior channels 607, 609 and interior ribs 608, 610. In the illustrated example, the garage door 601 includes first channels 607 having a first size and shape and second channels 609 having a second size and shape that are different than that of the first channels 607. The channels 607, 609 create corresponding ribs 608, 610 on an interior surface of the garage door 601. The window assembly 700 can include any of the features of the window assembly 100 described in the present application. For example, the exterior frame element 704 can include any of the features of the exterior frame element 104 described in the present application, and the interior frame element 706 can include any of the features of the interior frame element 104 described in the present application.

The exterior frame element 704 can include ribs 713, 715 (FIG. 37) that correspond to the channels 607, 609 of the garage door 601 such that the ribs 713, 715 provide a sealing arrangement with the garage door 601 to inhibit outside elements from moving through the window assembly 700 and an opening (e.g., the opening 411 of the garage door 401 shown in FIG. 32) of the garage door 601 to enter an interior of the garage. The exterior frame element 704 can have first ribs 713 that correspond to the size and shape of the channels 607 of the garage door 601, and the exterior frame element 704 can have second ribs 715 that correspond to the size and shape of the channels 609 of the garage door 601. In the illustrated example, the ribs 713, 715 are positioned proximate an outer edge of the exterior frame element 704. In various examples, the ribs 713, 715 can be substantially aligned with a protruding member of an outer engagement portion of the exterior frame element 704 (e.g., similar to protruding member 120 of the outer engagement portion 118 of the exterior frame element 104 shown in FIGS. 5-6 and 12-14). In some examples, the ribs 713, 715 can be sized to have substantially the same width W (FIGS. 12-14) as the protruding member 120. In some examples, the ribs 713, 715 and the protruding member 120 can be integral with each other. In some examples, a sealing material (e.g., similar to sealing material 119 shown in FIGS. 12-14) can be applied to each of the protruding member 120 and the ribs 713, 715 to provide for a sealing engagement between the window assembly and the garage door 101. The sealing material can be, for example, a foam hot melt sealant or the like.

While the illustrated example shows the exterior frame element 704 having two first ribs 713 and two second ribs 715, it should be understood that the exterior frame element 704 can have any suitable number of first ribs 713 and second ribs 715 depending on the number of first and second channels 607, 609 that align with the opening of the garage door 601 in which the window assembly 700 is being attached. While the illustrated example shows the exterior frame element have two different types of ribs 713, 715, it should be understood that the exterior frame element 704 can have any number of different types of ribs depending on the different types of channels of the garage door 601 that align with the opening of the garage door 601 in which the window assembly 700 is being attached. The ribs 713, 715 can be positioned at any location on the exterior frame element 704 that allows for the ribs to align with corresponding channels on the garage door 601, and the ribs 713, 715 can take any suitable shape that corresponds to the shape of the corresponding channels. While the illustrated example only shows ribs 713, 715 on a first side of the exterior frame element 704, it should be understood that the other side of the exterior frame element 704 can have ribs 713, 715 that align with the corresponding channels 607, 609 of the garage door 601.

The interior frame element 706 can include slots 717, 719 (FIG. 36) that correspond to the ribs 608, 610 of the garage door 601 such that the slots 717, 719 provide a sealing arrangement with the garage door 601 to inhibit outside elements from moving through the window assembly 700 and into an interior of the garage. The interior frame element 706 can have first slots 717 that correspond to the size and shape of the ribs 608 of the garage door 601, and the interior frame element 706 can have second slots 719 that correspond to the size and shape of the ribs 610 of the garage door 601. In the illustrated example, the slots 717, 719 are positioned proximate an outer edge of the interior frame element 706. While the illustrated example shows the interior frame element 706 having two first slots 717 and two second slots 719, it should be understood that the interior frame element 706 can have any suitable number of first slots 717 and second slots 719 depending on the number of first and second ribs 608, 610 that align with the opening of the garage door 601 in which the window assembly 700 is being attached. While the illustrated example shows the interior frame element 706 have two different types of slots 717, 719, it should be understood that the interior frame element 706 can have any number of different types of slots depending on the different types of ribs of the garage door 601 that align with the opening of the garage door 601 in which the window assembly 700 is being attached. The slots 717, 719 can be positioned at any location on the interior frame element 706 that allows for the slots to align with corresponding ribs on the garage door 601, and the slots 717, 719 can take any suitable shape that corresponds to the shape of the corresponding ribs. While the illustrated example only shows slots 717, 719 on a first side of the interior frame element 706, it should be understood that the other side of the interior frame element 706 can have slots 717, 719 that align with the corresponding channels 607, 609 of the garage door 601.

The window assemblies 100, 700 described in the present application are advantageous because of the case of manufacturing and the case of assembling. For example, in various implementations, the window assemblies 100, 700 can be manufactured by injection molding, where a single mold can be used to make the interior and exterior frame elements regardless of the thickness of the garage door to which the window assemblies will be attached. In various implementations, one or molds can be used to create the interior and exterior frame elements, where the one or more molds can have interchangeable molding elements that allow for the interior and exterior frame elements to have or not have certain features (e.g., ribs and/or channels for aligning with a garage door), as well as allow for a length of the inner engagement portion of the interior and/or exterior frame elements to be easily customizable based on the thickness of the window glazing being used for the window assembly and/or the thickness of garage door to which the window assembly will be attached.

An example method includes using a mold that is shaped and configured to make the exterior and interior frame elements 104, 106 for the window assembly 100 described in the present application. For example, the mold can include various molding elements that are configured to cause the exterior and interior frame elements 104, 106 to take any of the forms described in the present application. Referring to the exterior frame element 104, the various molding elements can be configured to create the external portion 112, the internal portion 110, the outer engagement portion 118, the inner engagement portion 122, the openings 132 (with or without protruding members 134), and/or openings 150 (for attaching an impact element, such as impact element 200 or impact 300 described in the present application). For example, one or more molding elements for creating the inner engagement portion 122 can include a cavity that allows for the protruding member(s) 128 of the inner engagement portion 122 to be formed during the molding process. The same mold can be used to create the interior frame element 106, where the same molding element(s) for creating the exterior frame element 104 are used to create the corresponding external portion 116, internal portion 114, outer engagement portion 136, inner engagement portion 140, and/or openings 144 (with or without protruding members 145) of the interior frame element 106. For example, the molding element(s) used for creating the protruding member(s) 128 of the inner engagement portion 122 of the exterior frame element 104 can be used to create the protruding member(s) 142 of the inner engagement portion 140 of the interior frame element 106.

In some implementations, one or more molding elements of the mold can be interchangeable with one or more alternative molding elements, such that a simple change of the molding element(s) with an alternative molding element(s) adjusts a feature of the window assembly 100. For example, the molding element(s) used for creating the protruding member 128 of the inner engagement portion 122 of the exterior frame element 104 can be replaced with alternative molding element(s) prior to creating the interior frame element 106 such that the protruding member(s) 142 of the inner engagement portion 140 of the interior frame element 106 have a different length than the inner engagement portion 122 of the exterior frame element 106. For example, the cavity created by the alternative molding element(s) for creating the inner engagement portion 140 of the interior frame element 106 can be deeper than the molding element(s) for creating the inner engagement portion 122 of the exterior frame element 104 such that the protruding members 142 of the interior frame element 106 have a greater length than the protruding members 128 of the exterior frame element 104. The mold for creating the exterior and interior frame elements 104, 106 can include any suitable number of alternative molding elements that are interchangeable such that the length of the protruding member(s) 142 of the inner engagement portion 140 of the interior frame element 106 can take any suitable length relative to the length of the protruding member(s) 128 of the inner engagement portion 122 of the exterior frame element 104.

In situations in which the length of the of the inner engagement portion 122 of the exterior frame element 104 and the inner engagement portion 140 of the interior frame element 106 are to be equal, the molding element(s) for creating these features do not need to be interchanged prior to making the interior frame element 106. In situations where the length of the inner engagement portion 140 of the interior frame element 106 is to be different than the length of the inner engagement portion 122 of the exterior frame element 104, alternative molding element(s) can replace the molding element(s) used to create the inner engagement portion 122 of the exterior frame element 104 such that the cavity formed by the molding element(s) for creating the protruding member(s) 142 of the inner engagement portion 140 of the interior frame element 106 is configured to create protruding member(s) 142 having a different length than the protruding members 128 of the exterior frame element 104.

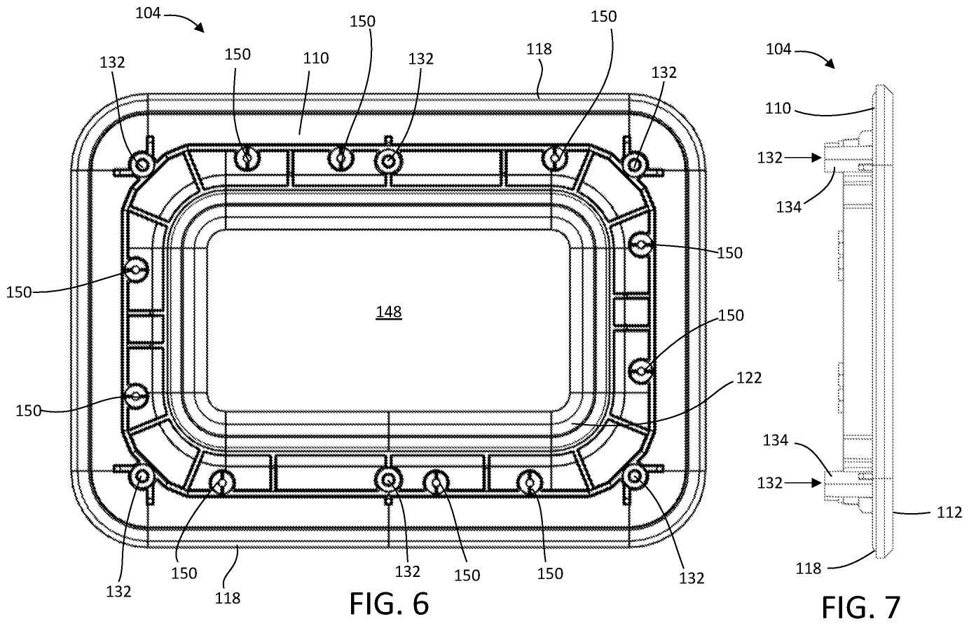

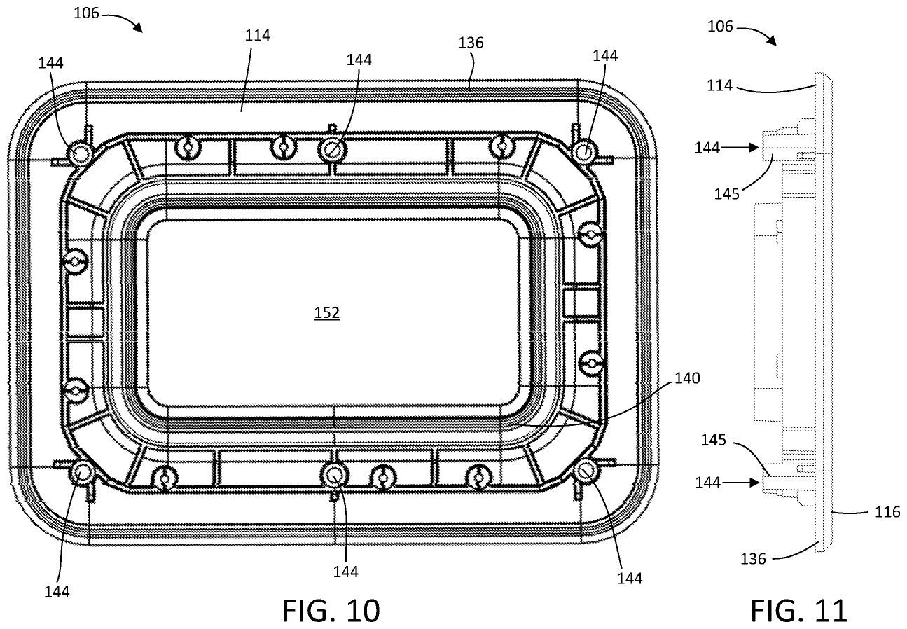

In some implementations, because the same mold is being used to create both the interior frame element 106 and the exterior frame element 104, one or more features of one of the interior or exterior frame element 104, 106 may be included on the other of the interior and exterior frame element 104, 106. For example, referring to FIGS. 5-6, the exterior frame element 104 is shown as having openings 150 for attaching an impact element thereto. Referring to FIGS. 9-10, in situations where the same mold that was used to create the exterior frame element 104 shown in FIGS. 5-6, the interior frame element 106 may include similar openings to the openings 150 of the exterior frame element 104 even though the interior frame element 106 does not require such openings because an impact element is not being attached thereto.

The use of a mold with interchangeable molding elements for creating the inner engagement portions 122, 140 of the exterior and interior frame elements 104, 106 is advantageous because it allows for the length of the inner engagement portion 140 of the interior frame element 106 to be adjusted while the length of the inner engagement portion 122 of the exterior frame element remains constant, which allows for the window assembly 100 created using such a manufacturing method to be easily adjustable to fit to any size garage door (regardless of the thickness of the garage door and/or the thickness of the window glazing of the window assembly). Accordingly, this manufacturing method saves manufacturing and changeover time compared to having separate dedicated molds for each specific frame configuration based on the thickness of the garage door and/or the thickness of the window glazing.

Similar to the manufacturing method described above for creating the window assemblies 100, a single mold can be used to create the exterior frame element 504 (shown in FIGS. 33-34) and/or the window assembly 700 (shown in FIGS. 35-37) described in the present application. As described herein, the frame element 504 can include any of the features of the frame element 104 described in the present application, but the frame element 504 can also include rib(s) 513, 515. Also as described herein, the window assemblies 700 described herein can include any of the features of the window assemblies 100, but the exterior and/or interior frame elements 704, 706 can include rib(s) 713, 715 and/or channel(s) 717, 719. A manufacturing method for creating the exterior frame element 504 and/or the window assemblies 700 can include using a mold with interchanging molding elements for creating the ribs and/or channels discussed with reference to the exterior frame element 504 and the window assemblies 700. For example, in situations where rib(s) and/or channel(s) are not included in creating the window assembly, the molding element(s) for creating the interior and exterior frame elements would be configured to not include such rib(s) or channel(s). In situations in which rib(s) and/or channel(s) are to be included on one or both of the interior and exterior frame elements, alternative molding elements can replace one or more molding elements of the mold such that the alternative molding elements are configured to include the rib(s) and/or channel(s) on one or both of the interior and exterior frame elements.

While the window assemblies 100, 700 and the manufacturing methods for making the window assemblies 100, 700 described in the present application refer to the adjustability of the length of the inner engagement portion 140 of the interior frame element 106 while the length of the inner engagement portion 122 of the exterior frame element 104 remains constant, it should be understood that the window assemblies can be configured such that the length of the inner engagement portion 122 of the exterior frame element 104 is configured to change based on the thickness of the garage door and/or the thickness of the window glazing while the length of the inner engagement portion 140 of the interior frame element 106 remains constant.

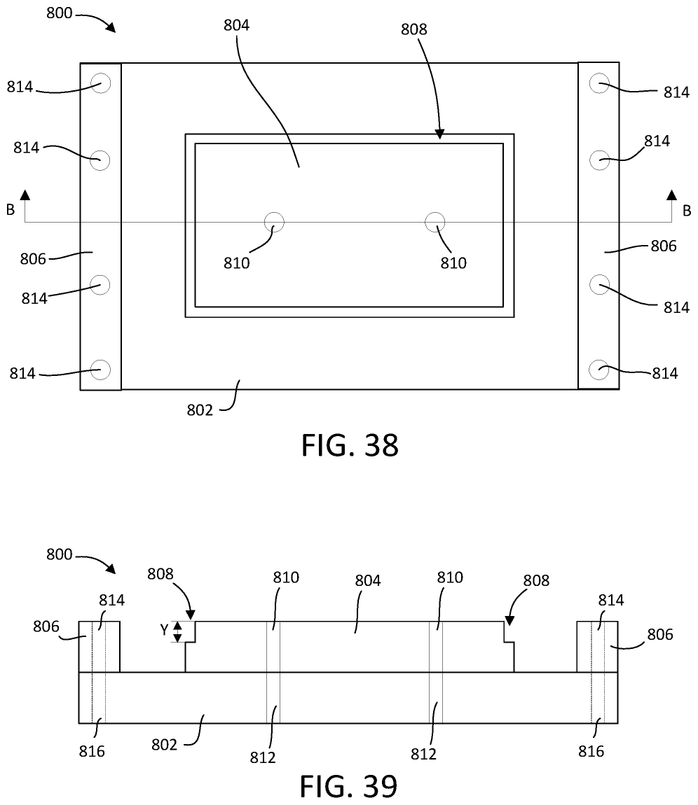

FIGS. 38-43 illustrate an example mold assembly 800 that can be used to make interior and exterior frame elements of a window assembly (e.g., any interior or exterior frame element described in the present application). For example, the mold assembly 800 can be used with any of the manufacturing methods described in the present application to create interior and exterior frame elements. Referring to FIGS. 38 and 39, the mold assembly 800 can include a base 802 and one or more molding elements. In the illustrated example, the mold assembly 800 includes a central molding element 804 and side molding elements 806, where each of the central molding element 804 and the side molding elements 806 can be configured to be interchangeable with one or more alternative versions of the respective central molding element 804 and side molding elements.

Still referring to FIGS. 38-39, the central molding element 804 can be configured to at least partially form the inner engagement portion 122 of the exterior frame element 104 described in the present application, and the central molding element 804 can also be configured to at least partially form the inner engagement portion 140 of the interior frame element 106 described in the present application. For example, the central molding element 804 can include a channel or step 808 having a depth Y (FIG. 39), where molding material is inserted into the channel or step 808 during the molding process to create the inner engagement portion 122 and/or the inner engagement portion 140. The length of the inner engagement portion 122, 140 is based on the depth Y of the channel or step 808. Referring to FIG. 38, the channel or step 808 can extend around an entirety of the outer edge of the central molding element 804 such that the inner engagement portion 122, 140 created using the central molding element continuously extends around the window glazing opening of the interior and/or exterior frame element. In other examples, the channel or step 808 can take any other suitable form depending on the desired shape of the inner engagement portion 122, 144. In various examples, the channel or step 808 of the central molding element 804 partially defines an area for receiving molding material that is used to make the inner engagement portion 122, 140, and one or more other portions of the mold assembly (not shown) define the remaining portions of the area for receiving molding material that is used to make the inner engagement portion 122, 140.

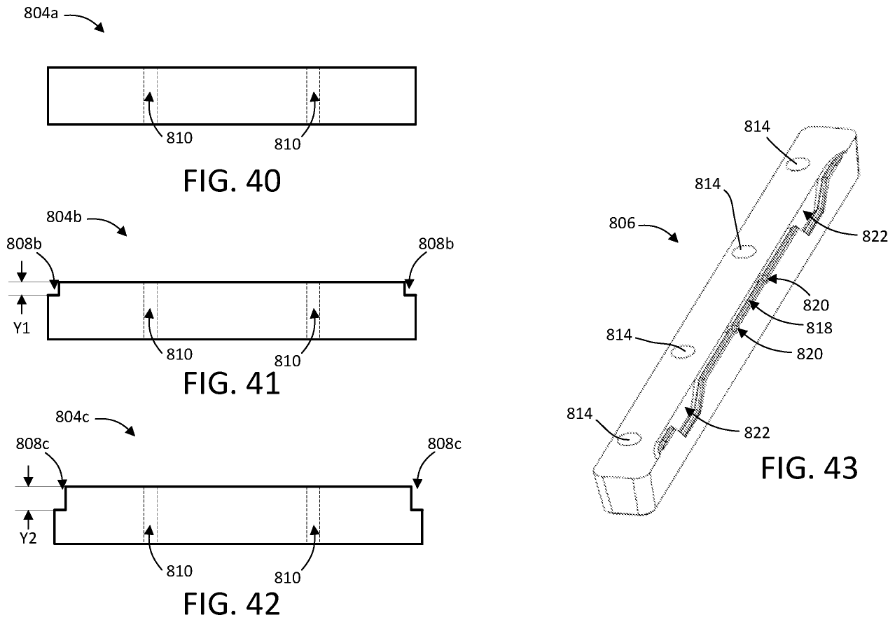

In examples where a length of the inner engagement portion 140 (e.g., the length X1 shown in FIG. 12) is equal to a length of the inner engagement portion 122 (e.g., the length X4 shown in FIG. 12), the same central molding element 804 can be used. In examples where a length of the inner engagement portion 140 (e.g., the lengths X1, X2 shown in FIGS. 13-14, respectively) is greater than the length of the inner engagement portion (e.g., the length X4 shown in FIGS. 12-14), an alternative central molding element 804 can be used. FIGS. 40-42 show various examples of central molding elements 804a-804c that can be removably attached to the base 802 such that the central molding element 804 of the mold assembly 800 is interchangeable depending on the desired length of the inner engagement portion. FIG. 40 shows a central molding element 804a that does not include a step or channel 808 such that the inner length of the inner engagement portion 122, 140 is less than examples where the central molding element 804 includes such a step or channel 808. FIG. 41 shows a central molding element 804b having a step or channel 808b having a depth Y1 such that the central molding element 804b is configured to form an inner engagement portion 122, 140 having a greater length than that formed by the central molding element 804a. FIG. 42 shows a central molding element 804c having a step or channel 808c having a depth Y2 that is greater than the depth Y1 such that the central molding element 804c is configured to form an inner engagement element 122, 140 having a greater length than the central molding element 804b.

Referring to FIGS. 38-42, the central molding elements 804, 804a-804c can include openings 810 that are configured to align with openings 812 of the base 802 such that a fastener can be inserted into the openings 810, 812 to removably attach the desired central molding elements 804, 804a-804c to the base 802 depending on the desired length of the inner engagement portion 122, 140. While the central molding elements 804, 804a-804c are described being removably attached to the base 802 by one or more fasteners, it should be understood that the central molding elements 804, 804a-804c can be removably attached to the base 802 by any other suitable means. While the central molding elements 804, 804a-804c are shown as having two openings 810 for attaching the central molding elements to the base 802, it should be understood that the central molding elements and base can have any suitable number of openings for attaching the central molding elements to the base.

Referring to FIG. 43, in some examples, the side molding elements 806 can include a channel or step 818 that is configured to at least partially form ribs for the interior and/or exterior frame elements of the window frame assembly. The channel or step 818 can take any suitable form that is capable of receiving molding material to form ribs that are positioned to align with channels or grooves on a garage door. In the example shown in FIG. 43, the channel or step 818 includes first portions 820 for creating first ribs (e.g., the first ribs 513 shown in FIG. 34) and second portions 822 for creating second ribs (e.g., the second ribs 515 shown in FIG. 34). Referring to FIGS. 38-39, the side molding elements 806 do not include a channel or step 818, which can be the type of side molding element 806 that is used if the window assembly does not have ribs or channels. In some examples, the side molding elements 806 can include protruding portions proximate a channel or step, or otherwise located proximate a side edge of the side molding elements 806, that are configured to create channels on the window assembly for aligning with ribs of a garage door.

Referring to FIGS. 38 and 43, the side elements 806 can include openings 814 that are configured to align with openings 816 of the base 802 such that a fastener can be inserted into the openings 814, 816 to removably attach the desired side molding element 806 to the base 802. The type of side element 806 being used can depend on whether the window assembly is going to have ribs and/or channels for aligning with the garage door. If the window assembly does have ribs and/or channels, there could also be various interchangeable side molding elements that have different number and/or shapes for the ribs and/or channels. While the side molding elements 806 are described being removably attached to the base 802 by one or more fasteners, it should be understood that the side molding elements 806 can be removably attached to the base 802 by any other suitable means. While the side molding elements 806 are shown as having four openings 814 for attaching the side molding elements 806 to the base 802, it should be understood that the side molding elements 806 and base 802 can have any suitable number of openings for attaching the side molding elements to the base.

The illustrated examples are shown only as including central molding element 804 used for forming the inner engagement portions (e.g., inner engagement portion 122 of the exterior frame element and inner engagement portion 140 of the interior frame element 106) and side molding elements 806 for forming or not forming one or more ribs or channels for aligning with corresponding channels and ribs on a garage door. It should be understood that the mold assembly 800 can include one or more additional molding elements to that are used to form other portions of the interior and/or exterior frame elements described in the present application. The other molding elements can be interchangeable as described with reference to the central molding element 804 and the side molding elements 806, or the other molding elements can be irremovably fixed to the base 802 of the mold assembly 800.

A method for assembling a garage door includes providing a garage door having an opening for receiving a window assembly. The method further includes providing a window assembly that includes an exterior frame element (e.g., any exterior frame element described in the present application), and interior frame element (e.g., any interior frame element described in the present application), and a window glazing (e.g., any window glazing described in the present application). The method can further include providing an exterior frame element of the window assembly that includes an inner engagement portion (e.g., the inner engagement portion 122 described in the present application) having a first length. The method can further include determining a thickness of the garage door and/or a thickness of the window glazing, and providing an interior frame element having an inner engagement portion (e.g., the inner engagement portion 140 described in the present application) having a second length that is based on the determined thickness of the garage door. In various examples, the second length of the inner engagement portion of the interior frame element can be greater than or equal to the first length of the inner engagement portion of the exterior frame element.

In various implementations, the method includes attaching the interior frame element to the exterior frame element at the opening in the garage door, where the window glazing is positioned between the interior and exterior frame elements and disposed within the opening of the garage door. The interior and exterior frame elements can be attached by any suitable means, such as, for example, any means described in the present application. The window assembly can be attached to the garage door by a clamping force due to the attachment between the interior and exterior frame elements. In some examples, an adhesive or other fastening member can be used to attach the interior and/or exterior frame elements to the garage door. In some implementations, the method includes securing an impact element (e.g., any impact element described in the present application) to the exterior frame element prior to connecting the interior frame element to the exterior frame element. In some examples, the impact element is positioned to engage the garage door and the window glazing when the interior frame element and the exterior frame element are attached and positioned within the opening of the garage door.

While the method is described as providing an exterior frame element having an inner engagement portion having a first length, and then providing an interior frame element with an inner engagement portion having a second length that is determined based on the thickness of the garage door and/or the thickness of the window glazing, it should be understood that an alternative method can include providing an interior frame element having an inner engagement portion having a length, and then providing an exterior frame element having an inner engagement portion having a length that is determined based on a determined thickness of the garage door and/or the thickness of the window glazing. For this method, the window frame elements can be attached and secured to the garage door by the same means described above, and/or an impact element can be secured to the exterior frame element as described above.

Alone or in combination with the methods of assembling a garage described above, a method of assembling a garage door can include providing a garage door, and determining whether an interior and/or exterior of the garage door includes channels and/or ribs. The method can include providing an exterior frame element of a window assembly that includes ribs and/or channels that correspond to channels and/or ribs of the exterior of the garage door. The method can include providing an interior frame element of the window assembly that includes ribs and/or channels that correspond to channels and/or ribs of the interior of the garage door. If one of the interior and exterior of the garage door do not include such channels and/or ribs, the corresponding interior or exterior frame element provided does not include corresponding ribs or channels. The method can include aligning ribs and/or channels (if included) of the exterior frame element with corresponding channels and/or ribs (if included) of the exterior of the garage door when securing the window assembly to the garage door. The method can include aligning ribs and/or channels (if included) of the interior frame element with corresponding channels and/or ribs (if included) of the interior of the garage door when securing the window assembly to the garage door.

While the present application describes a window assembly for a garage door and manufacturing and assembling methods thereof, it should be understood that the window assemblies described in the present application and the manufacturing and/or assembling methods thereof can be used in any other suitable manner in which a window assembly is attached to a structure.

While various inventive aspects, concepts and features of the inventions may be described and illustrated herein as embodied in combination with exemplary embodiments, these various aspects, concepts and features may be used in many alternative embodiments, either individually or in various combinations and sub-combinations thereof. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A window assembly for attaching to a door or other surface, the window assembly comprising:
a frame comprising:
an interior frame element having a first internal surface, a first outer engagement portion extending from the first internal surface, and a first inner engagement portion extending from the first internal surface to a first external surface, wherein the first inner engagement portion is integrally connected to the first internal surface;
an exterior frame element having a second internal surface, a second outer engagement portion extending from the second internal surface to a second external surface, and a second inner engagement portion extending from the second internal surface, wherein the second inner engagement portion is integrally connected to the second internal surface;
wherein the interior frame element and the exterior frame element are configured to be connected to each other such that the first outer engagement portion and the second outer engagement portion engage the door or other surface; and
a window glazing disposed between the interior and exterior frame elements of the frame;
wherein the first inner engagement portion of the interior frame element and the second inner engagement portion of the exterior frame element are aligned with the window glazing; and
wherein a first length of the first inner engagement portion is greater than a second length of the second inner engagement portion.

2. The window assembly according to claim 1, wherein the first length of the first inner engagement portion is based on a thickness of the door or other surface to which the window assembly is attached, and wherein the second length of the second inner engagement portion is constant regardless of the thickness of the door or other surface to which the window assembly is attached.

3. The window assembly according to claim 1, wherein the first inner engagement portion defines an interior viewing channel having a length that is substantially equal to the first length, and wherein the second inner engagement portion defines an exterior viewing channel having a length that is substantially equal to the second length.

4. The window assembly according to claim 1, wherein the first inner engagement portion comprises a protruding member that extends continuously around a window glazing opening of the interior frame element.

5. The window assembly according to claim 1, wherein each of the interior and exterior frame elements are injection molded components.

6. The window assembly according to claim 1, further comprising an impact element configured to provide impact resistance to the window assembly, wherein the impact element is secured to the second internal surface of the exterior frame element.

7. The window assembly according to claim 6, wherein a first portion of the impact element is disposed between the interior frame element and the window glazing, and wherein a second portion of the impact element is configured to engage the garage door and transfer force applied to the window glazing to the garage door.

8. A garage door assembly comprising:
a garage door having an opening;
a window assembly comprising:
an interior frame element having a first internal surface, a first outer engagement portion extending from the first internal surface, and a first inner engagement portion extending from the first internal surface, wherein the first inner engagement portion is integrally connected to the first internal surface;
an exterior frame element having a second internal surface, a second outer engagement portion extending from the second internal surface, and a second inner engagement portion extending from the second internal surface, wherein the second inner engagement portion is integrally connected to the second internal surface;
a window glazing disposed between the interior and exterior frame elements such that the first inner engagement portion and the second inner engagement portion are aligned with the window glazing;
wherein a first length of the first inner engagement portion is greater than a second length of the second inner engagement portion; and
wherein the window assembly is positioned within the opening of the garage door such that the first outer engagement portion and the second outer engagement portion engage the garage door.

9. The garage door assembly according to claim 8, wherein the first length of the first inner engagement portion is based on a thickness of the door or other surface to which the window assembly is attached, and wherein the second length of the second inner engagement portion is constant regardless of the thickness of the door or other surface to which the window assembly is attached.

10. The garage door assembly according to claim 8, wherein the first inner engagement portion defines an interior viewing channel having a length that is substantially equal to the first length, and wherein the second inner engagement portion defines an exterior viewing channel having a length that is substantially equal to the second length.

11. The garage door assembly according to claim 8, wherein the first inner engagement portion comprises a protruding member that extends continuously around a window glazing opening of the interior frame element.

12. The garage door assembly according to claim 1, wherein each of the interior and exterior frame elements are injection molded components.

13. The garage door assembly according to claim 8, further comprising an impact element configured to provide impact resistance to the window assembly, wherein the impact element is secured to the second internal surface of the exterior frame element.

14. The garage door assembly according to claim 13, wherein a first portion of the impact element is disposed between the interior frame element and the window glazing, and wherein a second portion of the impact element is disposed between an exterior surface of the garage door and the second internal surface of the exterior frame element.

15. A method of assembling a garage door, the method comprising:
providing a garage door having an opening, the garage door having a thickness;
providing a window assembly, the window assembly comprising:
an exterior frame element having a first inner engagement portion that extends from a first internal surface of the exterior frame element, the first inner engagement portion having a first length;
an interior frame element having a second inner engagement portion that extends from a second internal surface of the exterior frame element, the second inner engagement portion having a second length that is greater than or equal to the first length; and
a window glazing;
securing the exterior frame element to the interior frame element such that the window assembly is attached to the garage door and the window glazing is positioned between the exterior and interior frame elements and disposed within the opening of the garage door;
wherein the second length of the second inner engagement portion of the interior frame element is determined based on the thickness of the garage door.

16. The method according to claim 15, wherein the second length of the second inner engagement portion of the interior frame element is equal to the first length of the first inner engagement portion of the exterior frame element when the thickness of the garage door is equal to a first thickness, and wherein the second length of the second inner engagement portion of the interior frame element is greater than the first length of the first inner engagement portion of the exterior frame element when the thickness of the garage door is equal to a second thickness that is greater than the first thickness.

17. The method according to claim 15, further comprising attaching an impact element to the first internal surface of the exterior frame element prior to securing the exterior frame element to the interior frame element.

18. The method according to claim 17, wherein a first portion of the impact element is disposed between the interior frame element and the window glazing, and wherein a second portion of the impact element is disposed between an exterior surface of the garage door and the first internal surface of the exterior frame element.

19. The method according to claim 15, wherein an exterior surface of the garage door comprises one or more channels, wherein the exterior frame element comprises one or more ribs, wherein the one or more ribs exterior frame element are disposed within the one or more channels of the garage door when the window assembly is attached to the garage door, and wherein the method further comprises applying an adhesive sealing material to the one or more ribs prior to attaching the window assembly to the garage door such that the adhesive sealant creates a sealed connection between the one or more ribs and the one or more channels of the garage door when the window assembly is attached to the garage door.

20. A method of manufacturing a window assembly for a garage door, the method comprising:
providing a mold for creating both an exterior frame element and an interior frame element of the window assembly, the mold having one or more detachable molding elements and one or more alternative molding elements, wherein the one or more alternative molding elements are configured to replace the one or more detachable molding elements in the mold, wherein the one or more detachable molding elements are configured to create a first inner engagement portion for the exterior frame element, and wherein each of the one or more detachable molding elements and the one or more alternative molding elements are configured to create a second inner engagement portion for the interior frame element;
creating the exterior frame element using the mold by injection molding such that the exterior frame element has the first inner engagement portion, wherein the inner engagement portion has the first length based on a cavity defined by the one or more detachable molding elements; and
creating an interior frame element using the mold by injection molding such that the interior frame element has the second inner engagement portion, wherein the second inner engagement portion has a second length based on one of the cavity defined by the one or more detachable molding elements or a second cavity defined by the one or more alternative molding elements;
wherein the second length of the second inner engagement portion is equal to the first length of the first inner engagement portion when the one or more detachable molding elements are used to create the interior frame element; and
wherein the second length of the second inner engagement portion is greater than the first length of the first inner engagement portion when the one or more alternative molding elements are used to create the interior frame element.

21. The method according to claim 20, further comprising determining whether to use the one or more detachable molding elements or the one or more alternative molding elements to create the interior frame element based on a thickness of the garage door to which the window assembly is to be attached.

22. The method according to claim 20, wherein the mold comprises one or more detachable rib molding elements that are configured to cause the created exterior frame element to have one or more ribs that are configured to align with one or more channels on the garage door to which the window assembly is to be attached.

23. The method according to claim 22, wherein the one or more detachable rib molding elements are removed prior to creating the interior frame element.
